(19) United States
(12) Patent Application Publication
(10) Pub. No.: US 2026/0264428 A1
(43) Pub. Date: Sep. 10, 2026

(54) RECORDING APPARATUS

(71) Applicant: SEIKO EPSON CORPORATION, Tokyo (JP)

(72) Inventors: Soshi OKAWA, SHIOJIRI-SHI (JP); Takeshi TOKUDA, SHIOJIRI-SHI (JP)

(21) Appl. No.: 19/554,783

(22) Filed: Mar. 3, 2026

(30) Foreign Application Priority Data
Mar. 6, 2025 (JP) 2025-035688

(51) Int. Cl. B41J 25/304; B41J 2/165

(52) U.S. Cl. CPC B41J 25/304; B41J 2/16538; B41P 2235/21

(57) ABSTRACT

A recording apparatus includes a conveyance path configured to convey a medium in a conveyance direction; a recording unit configured to perform recording on the medium, and to move in a direction in which the recording unit advances and retreats with respect to the conveyance path; a cleaning unit configured to clean the recording unit by moving with respect to the recording unit; and a restriction portion configured to switch between a restriction state in which movement of the recording unit is restricted and a restriction release state in which the movement of the recording unit is not restricted in accordance with an action of the cleaning unit.

### CROSS-REFERENCE TO RELATED APPLICATIONS

The present application is based on, and claims priority from JP Application Serial Number 2025-035688, filed Mar. 6, 2025, the disclosure of which is hereby incorporated by reference herein in its entirety.

### BACKGROUND

### 1. Technical Field

The present disclosure relates to a recording apparatus that performs recording on a medium.

### 2. Related Art

A problem to be solved by a liquid ejection apparatus described in JP-A-2024-11608 is that a moving section disposed movably is displaced from a predetermined position by a vibration or an impact applied to the moving section to thereby cause a failure. In view of such a problem, the liquid ejection apparatus described in JP-A-2024-11608 includes the moving section and a restriction member, and restricts movement of the moving section in a moving direction by the restriction member coming into contact with a part of the moving section.

JP-A-2024-11608 is an example of the related art.

In the liquid ejection apparatus described in JP-A-2024-11608, since the restriction member is a detachable member and is attached or detached by a service person, there is a possibility that the restriction member is not attached when necessary or the restriction member is not detached when unnecessary, and a desired purpose cannot be achieved in some cases.

### SUMMARY

A recording apparatus according to the present disclosure for solving the problem described above includes a conveyance path configured to convey a medium in a conveyance direction; a recording unit configured to perform recording on the medium, and to move in a direction in which the recording unit advances and retreats with respect to the conveyance path; a cleaning unit configured to clean the recording unit by moving with respect to the recording unit; and a restriction portion configured to switch between a restriction state in which movement of the recording unit is restricted and a restriction release state in which the movement of the recording unit is not restricted in accordance with an action of the cleaning unit.

### BRIEF DESCRIPTION OF THE DRAWINGS

FIG. 1 is a diagram illustrating a medium conveyance path of a printer.

FIG. 2 is a plan view of head surfaces of a line head.

FIG. 3 is a perspective view of a cap unit.

FIG. 4 is a block diagram showing a control system.

FIG. 5 is a diagram showing an operation transition of the line head and a shutter.

FIG. 6 is a diagram showing an operation of a wiper.

FIG. 7 is a perspective view of a head unit, a guide frame, and the cap unit.

FIG. 8 is a perspective view of the head unit, the guide frame, and the cap unit.

FIG. 9 is a perspective view of the head unit, the guide frame, and the cap unit.

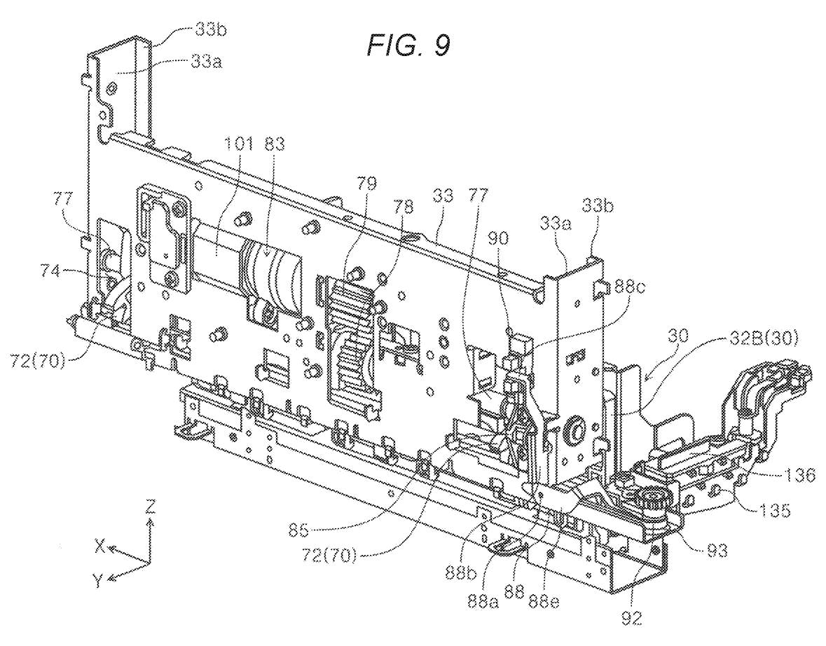

FIG. 10 is a perspective view of the head unit and a wiper carriage.

FIG. 11 is a perspective view of the head unit.

FIG. 12 is a perspective view of a reduction mechanism that transmits power from a head moving motor to a rotating body.

FIG. 13 is a perspective view of the rotating body.

FIG. 14 is a perspective view of the rotating body and a rack member.

FIG. 15 is a perspective view of the rotating body and the rack member.

FIG. 16 is a perspective view of the rotating body and the rack member.

FIG. 17 is a perspective view of the rotating body and the rack member.

FIG. 18 is a perspective view of a restriction portion for restricting movement of the head unit and the periphery of the restriction portion.

FIG. 19 is a perspective view of the restriction portion for restricting movement of the head unit and the periphery of the restriction portion.

FIG. 20 is a perspective view of the restriction portion for restricting movement of the head unit and the periphery of the restriction portion.

FIG. 21 is a perspective view of the wiper carriage and the periphery of the restriction portion for restricting the movement of the head unit.

FIG. 22 is a perspective view of the wiper carriage and the periphery of the restriction portion for restricting the movement of the head unit.

FIG. 23 is a cross-sectional view of a pin member and the rotating body.

FIG. 24 is a front view of the pin member and the rotating body.

FIG. 25 is a perspective view of the restriction portion for restricting movement of the head unit and the periphery of the restriction portion.

### DESCRIPTION OF EMBODIMENTS

The present disclosure will schematically be described below.

A recording apparatus according to a first aspect includes a conveyance path configured to convey a medium in a conveyance direction; a recording unit configured to perform recording on the medium, and to move in a direction in which the recording unit advances and retreats with respect to the conveyance path; a cleaning unit configured to clean the recording unit by moving with respect to the recording unit; and a restriction portion configured to switch between a restriction state in which movement of the recording unit is restricted and a restriction release state in which the movement of the recording unit is not restricted in accordance with an action of the cleaning unit.

According to the present aspect, since the recording apparatus includes the restriction portion capable of switching between the restriction state in which the movement of the recording unit is restricted and the restriction release state in which the movement of the recording unit is not restricted in accordance with the operation of the cleaning unit, it is possible to reliably achieve a desired purpose compared to a configuration in which the movement of the recording unit is manually restricted or the restriction thereof is manually released. That is, when it is necessary to restrict the movement of the recording unit, the movement of the recording unit can be more reliably restricted, and when it is necessary to allow the movement of the recording unit, the movement of the recording unit can be more reliably allowed.

In addition, since the switching of the state of the restriction portion is performed by the action of the cleaning unit, a dedicated power source for switching the state of the restriction portion is not required, and an increase in cost and size of the apparatus can be suppressed.

A second aspect is an aspect according to the first aspect, wherein a movement range of the cleaning unit includes an engagement position where the cleaning unit engages with the restriction portion, and the restriction portion takes the restriction state when the cleaning unit is located at the engagement position, and the restriction release state when the cleaning unit is displaced from the engagement position.

According to the present aspect, since the restriction portion takes the restriction state when the cleaning unit is located at the engagement position and takes the restriction release state when the cleaning unit is displaced from the engagement position, it is possible to easily realize the state switching of the restriction portion according to the operation of the cleaning unit.

Note that the expression "the cleaning unit engages with the restriction portion" is not limited to when the cleaning unit is directly engaged with the restriction portion, but also includes when the cleaning unit indirectly engages with the restriction portion via another member.

A third aspect is an aspect according to the second aspect, further including a moving device configured to move the recording unit, wherein the moving device includes a rotating body, and the restriction portion restricts rotation of the rotating body in the restriction state and allows the rotation of the rotating body in the restriction release state.

According to this aspect, the restriction state can be easily achieved by restricting the rotation of the rotating body. In addition, it is possible to easily restrict the movement of the recording unit with weak external force compared to a configuration in which the restriction portion directly restricts the movement of the recording unit.

Note that this aspect may be dependent from not only the second aspect but also the first aspect.

A fourth aspect is an aspect according to the third aspect, wherein the rotating body includes a pinion constituting a rack-and-pinion mechanism, the restriction portion includes a pin member configured to advance and retreat with respect to the pinion, and the pin member is configured to advance to a position where rotation of the pinion is inhibited in the restriction state, and retreat to a position where the rotation of the pinion is allowed in the restriction release state.

According to this aspect, the restriction state can be achieved with a simple configuration using the pin member and the pinion.

A fifth aspect is an aspect according to the fourth aspect, wherein the pinion has a restraint portion configured to restrain the pin member set in the restriction state.

According to this aspect, since the pinion includes the restraint portion that restrains the pin member set in the restriction state, it is possible to prevent the pin member from being unintentionally switched from the restriction state to the restriction release state due to vibration, impact, or the like.

A sixth aspect is an aspect according to the fourth aspect, wherein the cleaning unit performs cleaning of the recording unit by linearly moving, and the pin member advances and retreats with respect to the pinion by a swing of a lever member that swings to transmit a moving action of the cleaning unit to the pin member.

According to this aspect, since there is adopted the configuration in which the pin member advances and retreats with respect to the pinion by the swing of the lever member, the moving operation of the cleaning unit can be transmitted to the pin member with a simple configuration.

Note that this aspect may be dependent from not only the fourth aspect described above but also the fifth aspect described above.

A seventh aspect is an aspect according to the sixth aspect, wherein play is provided to an engagement region between the lever member and the pin member.

According to the present aspect, since the play is provided to the engagement region between the lever member and the pin member, it is possible to prevent the lever member and the pin member from restraining the mutual actions, and the swing action of the lever member is smoothly converted into the linear action of the pin member.

An eighth aspect is an aspect according to any one of the first to seventh aspects, wherein the recording unit is configured to eject a liquid from a plurality of nozzles, and the cleaning unit wipes a nozzle surface of the recording unit by moving in a direction along the nozzle surface.

According to the present aspect, in the configuration in which the recording unit is capable of ejecting the liquid from the plurality of nozzles, and the cleaning unit wipes the nozzle surface of the recording unit, the functions and the advantages of any one of the first to seventh aspects described above are obtained.

A ninth aspect is an aspect according to any one of the second to seventh aspects, wherein the recording unit is configured to eject a liquid from a plurality of nozzles, the cleaning unit wipes a nozzle surface of the recording unit by moving in a direction along the nozzle surface, and the engagement position is located on a moving path of the cleaning unit.

According to the present aspect, in the configuration in which the recording unit is capable of ejecting the liquid from the plurality of nozzles, and the cleaning unit wipes the nozzle surface of the recording unit, the functions and the advantages of the second aspect described above are obtained.

A tenth aspect is an aspect according to any one of the first to seventh aspects, wherein a controller configured to control the cleaning unit brings the restriction portion into the restriction state when the apparatus is brought into in a power-off state.

According to this aspect, since the controller that controls the cleaning unit brings the restriction portion into the restriction state when the apparatus is brought into the power-off state, the movement of the recording unit can be restricted when the apparatus is in the power-off state. As a result, for example, when the recording unit is capped by the cap portion in the power-off state, a state in which the cap portion caps the recording unit can be appropriately maintained.

Note that the present aspect may be dependent from not only the first to seventh aspects described above but also the eighth aspect or the ninth aspect described above.

An eleventh aspect is an aspect according to any one of the first to seventh aspects, wherein a controller configured to control the cleaning unit brings the restriction portion into the restriction state when the apparatus makes a transition to a power saving mode.

According to this aspect, since the controller that controls the cleaning unit sets the restriction portion to the restriction state when the apparatus makes the transition to the power saving mode, the movement of the recording unit can be restricted when the apparatus is in the power saving mode. As a result, for example, when the recording unit is capped by the cap portion in the state of the power saving mode, a state in which the cap portion caps the recording unit can be appropriately maintained.

Note that the present aspect may be dependent from not only the first to seventh aspects described above but also the eighth to tenth aspects described above.

The present disclosure will specifically be described below.

An inkjet printer 1 will hereinafter be described as an example of a recording apparatus that performs recording on a medium. The inkjet printer 1 will hereinafter be referred to simply as a printer 1.

Note that an X-Y-Z coordinate system illustrated in the drawings is an orthogonal coordinate system, wherein arrow directions are positive (+) directions, and opposite directions to the positive directions are negative (-) directions. The X-axis direction is an apparatus width direction and is a width direction crossing a conveyance direction of the medium on which recording is performed. When viewed from an operator of the printer 1, the +X direction corresponding to the left side and the -X direction corresponds to the right side. Hereinafter, in some cases, the X-axis direction is referred to as a medium width direction or simply as a width direction.

The Y-axis direction is an apparatus depth direction and is a direction along the medium conveyance direction during recording. The +Y direction is a direction from an apparatus back surface toward an apparatus front surface and the -Y direction is a direction from the apparatus front surface toward the apparatus back surface. In the present embodiment, out of side surfaces constituting the surroundings of the printer 1, the side surface at the +Y direction side corresponds to the apparatus front surface and the side surface at the -Y direction side corresponds to the apparatus back surface.

The Z-axis direction is a direction along a vertical direction and is an apparatus height direction. The +Z direction is a vertically upward direction, and the -Z direction is a vertically downward direction.

Note that, in the following, in some cases, a direction in which a medium is conveyed is referred to as "downstream" and a direction opposite to that direction is referred to as "upstream".

### Medium Conveyance Path in Printer

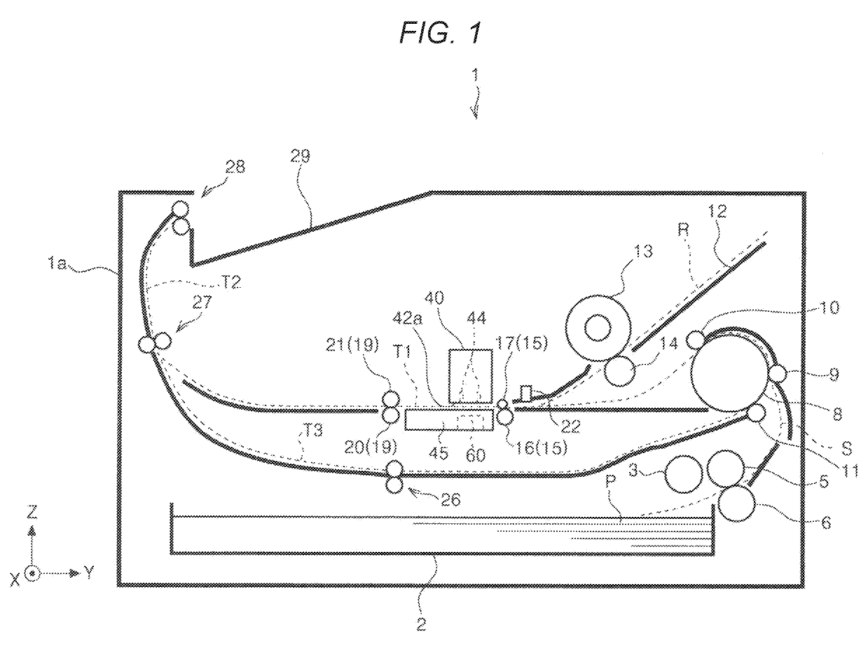

A medium conveyance path in the printer 1 will be described below with reference to FIG. 1. In FIG. 1, the medium conveyance path is indicated by a broken line.

A reference symbol S denotes a feeding path for feeding the medium from a medium storage cassette 2, and is a path from the medium storage cassette 2 to a first conveyance roller pair 15 via a flipping roller 8 in the present embodiment.

A reference symbol T1 denotes a first conveyance path which faces a line head 40 as an example of a recording unit, and through which the medium is conveyed. In the present embodiment, the first conveyance path T1 is a path from the first conveyance roller pair 15 to a second conveyance roller pair 19. Note that in the present embodiment, the first conveyance path T1 is parallel to the X-Y plane, but may have an angle with the X-Y plane.

A reference symbol T2 denotes a second conveying path which is coupled to the first conveying path T1 to curve the medium upward to be flipped after the line head 40 performs recording on the medium. In the present embodiment, the second conveying path T2 is a path from the second conveyance roller pair 19 to a discharge roller pair 28.

A reference symbol T3 denotes a third conveyance path, wherein the third conveyance path is located below the first conveyance path T1, receives the medium reversely fed through the second conveyance path T2, and guides the medium to the feeding path S. In the present embodiment, the third conveyance path T3 is a path from a third conveyance roller pair 27 to the feeding path S via a fourth conveyance roller pair 26.

The first conveyance path T1, the second conveyance path T2, the third conveyance path T3, and the line head 40 are disposed inside an apparatus main body 1a.

A configuration on the path will hereinafter be described in order from the feeding path S.

A reference symbol P denotes media stored in the medium storage cassette 2. An example of the media is recording paper. The medium storage cassette 2 is detachably attached to the apparatus main body 1a of the printer 1 from the apparatus front surface.

A pickup roller 3 driven by a motor (not shown) is disposed above the medium storage cassette 2. The pickup roller 3 is capable of advancing to and retracting from the media stored in the medium storage cassette 2 and rotates while being in contact with the media stored in the medium storage cassette 2 to feed the media from the medium storage cassette 2 in the +Y direction.

A feed roller 5 driven by a motor (not shown) and a separation roller 6 to which rotational torque is applied by a torque limiter (not shown) are disposed downstream with respect to the medium storage cassette 2. The media fed from the medium storage cassette 2 are nipped by the feed roller 5 and the separation roller 6 to be separated and the separated medium is further fed downstream.

A flipping roller 8 driven by a motor (not shown) is disposed downstream of the feed roller 5 and the separation roller 6. A first nip roller 9, a second nip roller 10, and a third nip roller 11 are disposed around the flipping roller 8. The medium fed through the feeding path S is nipped by the flipping roller 8 and the first nip roller 9, and is further nipped by the flipping roller 8 and the second nip roller 10 to be conveyed. A conveyance direction of the medium is reversed from the +Y direction to the -Y direction by the flipping roller 8, and the medium is conveyed downstream.

Further, the printer 1 includes a feeding path R for feeding the medium from the medium placing section 12 in addition to the feeding path S for feeding the medium from the medium storage cassette 2. The medium placing section 12 supports the medium in an inclining posture, and the medium thus supported is conveyed to the first conveyance roller pair 15 by a feed roller 13 driven by a motor (not shown). A reference symbol 14 denotes a separation roller to which rotational torque is applied by a torque limiter (not shown).

The first conveyance roller pair 15 including a driving roller 16 driven by a motor (not illustrated) and a driven roller 17 that can be driven by the driving roller 16 is disposed downstream of the flipping roller 8. The driven roller 17 is pressed toward the driving roller 16 by a pressing member (not shown).

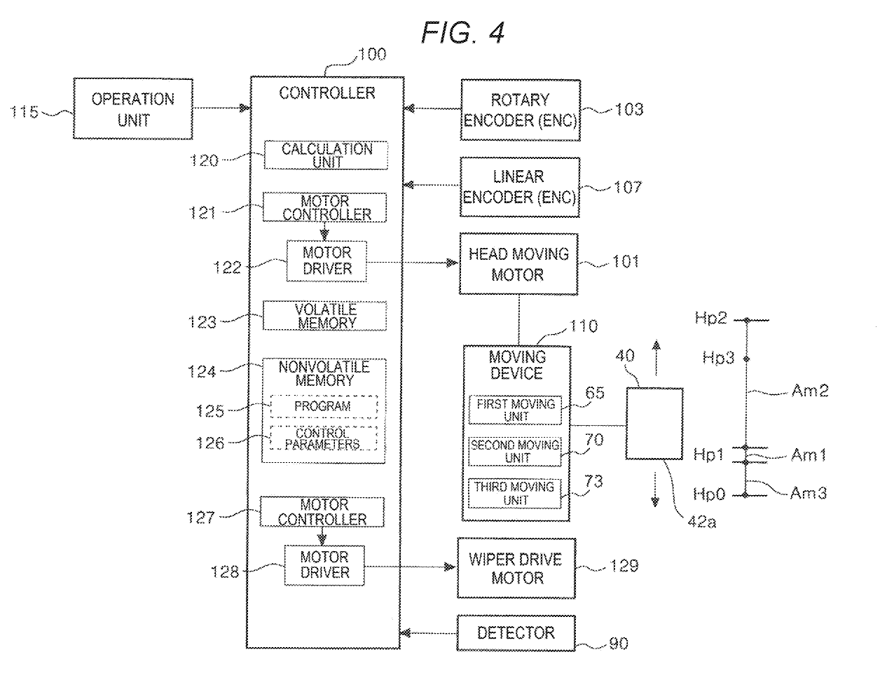

A medium detector 22 is disposed upstream of the first conveyance roller pair 15. A controller 100 (see FIG. 4) described later can determine, based on detection information of the medium detector 22, a position of a leading end of the medium with respect to the line head 40, and can position the medium at, for example, a recording start position.

The line head 40 is an example of the recording unit that performs recording on the medium. Further, the line head 40 is an example of a liquid ejection head that ejects ink, which is an example of a liquid, onto the medium to perform recording. The line head 40 is the liquid ejection head in which a plurality of nozzles 44 for ejecting the ink is arranged so as to cover the entire area of the medium in the medium width direction. The line head 40 is configured as the liquid ejection head long in the medium width direction and capable of performing recording in the entire area in the medium width direction without moving in the medium width direction.

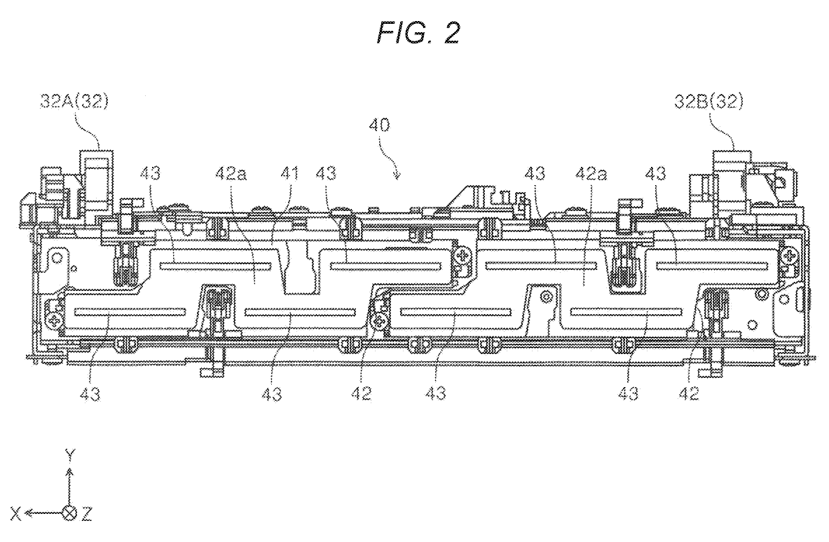

A reference symbol 42a denotes a head surface serving as a surface facing the medium. The head surface 42a may also be referred to as a liquid ejection surface or a nozzle surface. The head surface 42a is formed of a plate member 42 (see FIG. 2) described later. The head surface 42a is parallel to the medium conveyance direction at a position opposed to the line head 40, that is, the Y-axis direction. Further, the head surface 42a is parallel to the X-Y plane.

The printer 1 includes an ink container (not shown), and the ink to be ejected from the line head 40 is supplied from the ink container to the line head 40 via an ink tube (not shown).

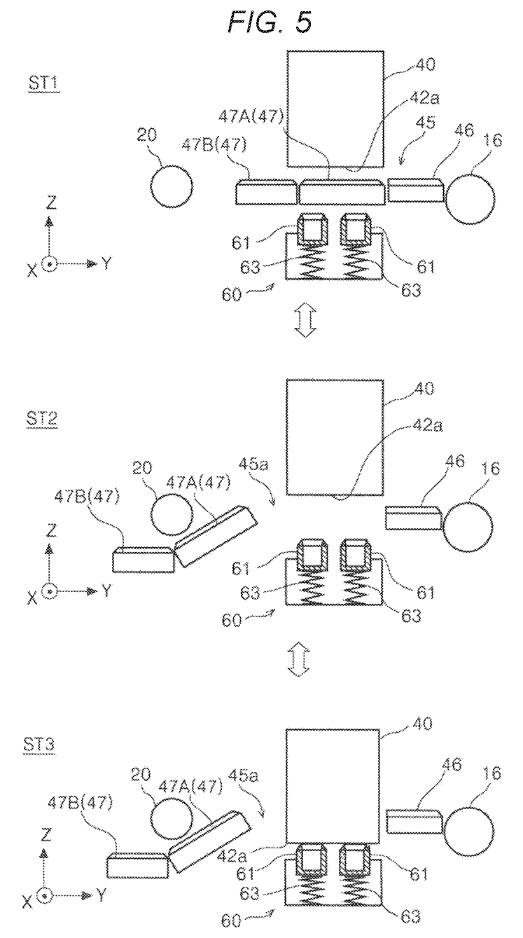

An opposed portion 45 is disposed at a position opposed to the head surfaces 42a of the line head 40. The opposed portion 45 according to the present embodiment includes a shutter 47 (see FIG. 5) that can be opened and closed, and in a state where the shutter 47 is closed, the opposed portion 45 supports the medium to thereby define a gap between the medium and the head surface 42a. The gap between the opposed portion 45 and the head surface 42a is hereinafter referred to as a platen gap in some cases.

The line head 40 is disposed movably in a direction of advancing and retracting with respect to the opposed portion 45, that is, in an adjustment direction of the platen gap. In the present embodiment, the adjustment direction of the platen gap is parallel to the Z-axis direction.

Hereinafter, in some cases, the movement of the line head 40 or other components toward the +Z direction is referred to as "rising" and the movement thereof toward the -Z direction is referred to as "falling".

As shown in FIG. 4, the line head 40 moves along the Z-axis direction by being provided with the power of a head moving motor 101 as an example of a drive source.

Here, a moving operation of the line head 40 will generally be described with reference to FIG. 4. The power of the head moving motor 101 is converted into an operation in the Z-axis direction of the line head 40 by a moving device 110. The moving device 110 will be described later once again.

The controller 100 that controls the head moving motor 101 moves up or down the line head 40 in accordance with a thickness of the medium based on a medium type contained in print data thus received, to adjust the platen gap. For example, defining a position of the line head 40 when performing recording on plain paper as a first head position, when recording is performed on dedicated paper thicker than the plain paper, the line head 40 is positioned at a second head position higher than the first head position. When the medium comes into contact with the line head 40 even when the second head position is selected, the line head 40 is positioned at a third head position higher than the second head position.

In FIG. 4, reference symbols Am1, Am2, and Am3 denote movement areas of the line head 40 with reference to the head surface 42a. The movement areas of the line head 40 include a first area Am1 and a second area Am2 farther from the conveyance path Ta than the first area Am1. The first area Am1 includes the first head position, the second head position, and the third head position described above. Obviously, the first area Am1 may further include another head position. The second area Am2 includes a wiping position Hp3 at which wiping of the head surface 42a is performed by a wiper 136 described later. Further, in the present embodiment, the movement areas of the line head 40 include a third area Am3 lower than the first area Am1.

When the line head 40 moves to a position Hp2, which is the uppermost position in the second area Am2, the gap between the opposed portion 45 and the head surface 42a is made the widest. Accordingly, when a jam occurs, the jammed medium can be removed. Hereinafter, the position Hp2 is referred to as a jam handling position of the line head 40.

A position Hp1 is a recording position where recording is performed on the medium. The position Hp1 changes in accordance with the type of the medium as described above. That is, the recording position Hp1 includes the first head position, the second head position, and the third head position described above.

A position Hp0 is the lowermost position in the third area Am3. At this position, cap portions 61 described later cover the head surfaces 42a, and the position Hp0 is hereinafter referred to as a cap position of the line head 40.

Returning to FIG. 1, the second conveyance roller pair 19 including a driving roller 20 driven by a motor (not shown) and a driven roller 21 capable of rotating so as to follow the driving roller 20 is disposed downstream of the line head 40. The medium on which recording has been performed is conveyed downstream by the second conveyance roller pair 19.

The third conveyance roller pair 27 is disposed downstream of the second conveyance roller pair 19, and further, the discharge roller pair 28 is disposed downstream of the third conveyance roller pair 27. A face-down discharge path is formed between the third conveyance roller pair 27 and the discharge roller pair 28, and the medium on which recording has been performed is discharged to a discharge tray 29 by the discharge roller pair 28 in a state where the surface on which recording has been lastly performed faces down.

When performing recording on both surfaces of the medium, the medium is fed to the third conveying path T3 by the third conveyance roller pair 27 and the discharge roller pair 28 rotating reversely. The fourth conveyance roller pair 26 is disposed in the third conveyance path T3, and the medium having been fed to the third conveyance path T3 is fed to a space between the flipping roller 8 and the third nip roller 11 by the fourth conveyance roller pair 26. Then, the medium enters the feeding path S and is sent toward the first conveyance roller pair 15 once again by the flipping roller 8. By providing such a third conveyance path T3, recording can be performed on both surfaces of the medium.

### Configuration of Line Head

Then, the line head 40 will further be described with reference to FIG. 2.

As shown in FIG. 2, in the line head 40, a base 41 is provided with plate members 42. The base 41 is a structure that incorporates a flow path through which the ink supplied from the ink container (not shown) is supplied to head chips 43.

The plate member 42 is a metal plate and forms the head surface 42a.

The plate member 42 is provided with a plurality of head chips 43. The head chips 43 are each provided with the plurality of nozzles 44 (see FIG. 1) along the medium width direction. The plate members 42 and the head chips 43 are disposed to be flush with each other.

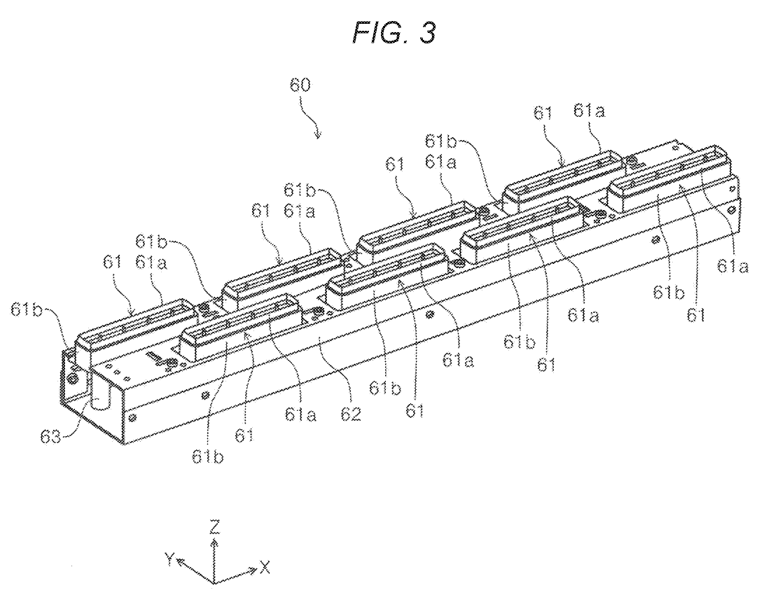

The head chips 43 are arranged along the X-axis direction, that is, the medium width direction alternately at an upstream position and a downstream position in the medium conveyance direction. In the present embodiment, four of the head chips 43 are arranged along the medium width direction at the upstream position, and four of the head chips 43 are arranged along the medium width direction at the downstream position. Accordingly, the cap portions 61 that are described later and cover the head chips 43 are disposed along the medium width direction alternately at the upstream position and the downstream position (see FIG. 3).

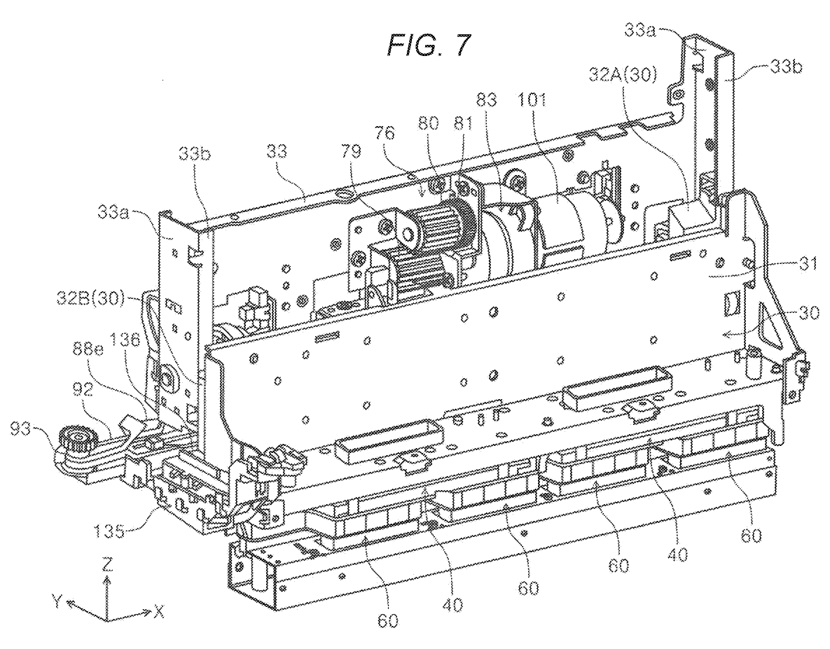

The line head 40 is provided to the unit frame 31 (see FIG. 7) and constitutes a head unit 30 (see FIG. 7) together with the unit frame 31. The head unit 30 is a structure including the line head 40. Therefore, in other words, members that constitute the head unit 30 are members provided to the line head 40.

The power of the head moving motor 101 (see FIG. 4) is transmitted to the unit frame 31, whereby the head unit 30, that is, the line head 40, move in the Z-axis direction.

### Configuration of Cap Unit

Then, a cap unit 60 will be described with reference to FIG. 3.

The cap unit 60 includes the cap portions 61 that cover the head chips 43. Since the head chips 43 are provided to the head surfaces 42a, the cap portion 61 can also be referred to as a member that covers a part of the head surface 42a. In addition, since the head chips 43 are each provided with the nozzles 44, the cap portion 61 can also be referred to as a member that covers the nozzles 44.

The plurality of cap portions 61 constitutes the cap unit 60. The cap unit 60 is disposed below the opposed portion 45.

In the cap unit 60, the base portion 62 includes the plurality of cap portions 61.

The cap portions 61 each have a shape elongated in the X-axis direction, and include a cap main body portion 61b made of a resin material or the like, and an elastic portion 61a, which is a region in contact with the head surface 42a and is made of an elastic material such as rubber. The cap main body portion 61b is held by the base portion 62 so as to be displaceable in the Z-axis direction, and a movement limit thereof in the +Z direction is defined by a restriction portion (not shown) provided to the base portion 62. The cap main body portion 61b is pressed toward the +Z direction by cap springs 63 as an example of a pressing member. In the present embodiment, two cap springs 63 are provided for one cap main body portion 61b.

A waste liquid tube (not shown) is coupled to each of the cap main body portions 61b. The waste liquid tube is coupled to a pump (not shown). When the pump is operated in the state where the cap portions 61 cover the head surfaces 42a, negative pressure is generated in the cap portions 61, whereby the ink is suctioned via the nozzles 44 of the line head 40.

The cap portions 61 are arranged along the X-axis direction, that is, the medium width direction alternately at an upstream position and a downstream position in the medium conveyance direction. In the present embodiment, four of the cap portions 61 are arranged at the upstream position, that is, at the +Y direction side, and four of the cap portions 61 are also arranged at the downstream position, that is, at the -Y direction side.

Such an arrangement of the cap portions 61 corresponds to an arrangement of the head chips 43 in the line head 40.

The cap portions 61 are exposed when the shutter 47 described later is moved from a blocking position to an open position.

### Configuration of Opposed Portion

Then, the opposed portion 45 will be described with reference to FIG. 5.

As shown in FIG. 5, the opposed portion 45 facing the line head 40 includes the upstream support portion 46 and the shutter 47 located downstream of the upstream support portion 46. In the present embodiment, the shutter 47 is formed by rotatably coupling an upstream shutter 47A and a downstream shutter 47B to each other. The shutter 47 is movable along the medium conveyance direction and is movable between the blocking position indicated by a state ST1 in FIG. 5 and the open position indicated by states ST2, ST3 in FIG. 5 by the power of a motor (not shown).

When the shutter 47 moves to the open position, an opening 45a is formed in the opposed portion 45, and the cap portions 61 are exposed inside the opening 45a.

In a state where the shutter 47 is at the open position, by the line head 40 falling as shown in the state ST3 in FIG. 5, the cap portions 61 can cover the head chips 43. On this occasion, the cap portions 61 are slightly pressed down in the -Z direction against the pressing force of the cap springs 63, whereby the cap portions 61 come into close contact with the head surfaces 42a. Note that, the falling movement of the line head 40 when the cap portions 61 are brought into close contact with the head surfaces 42a is referred to as a "capping operation" in some cases.

When the power of the apparatus is turned off or in a recording standby state when the power of the apparatus is on, the controller 100 (see FIG. 4) takes the state in which the cap portions 61 cover the head chips 43 in the state in which the shutter 47 is set to the open position. In addition, during a flushing operation for preventing the nozzles 44 from clogging, the controller 100 causes the ink to be ejected toward the cap portions 61 in the state where the shutter 47 described later is at the open position.

When recording data is received and recording is performed, the controller 100 raises the line head 40 to separate the head surfaces 42a from the cap portions 61, and moves the shutter 47 described later to the blocking position. Accordingly, the medium conveyed is prevented from entering the opening 45a of the opposed portion 45 or the posture of the medium is prevented from being disturbed. In addition, foreign matters such as paper dust are prevented from entering the cap portions 61 during the conveyance of the medium to deteriorate the performance of the cap portions 61.

Note that, in the present embodiment, the shutter 47 moves between the blocking position and the open position by a link mechanism (not shown) which is operated by a reverse rotation of the driving roller 20 constituting the second conveyance roller pair 19.

### Configuration of Wiper

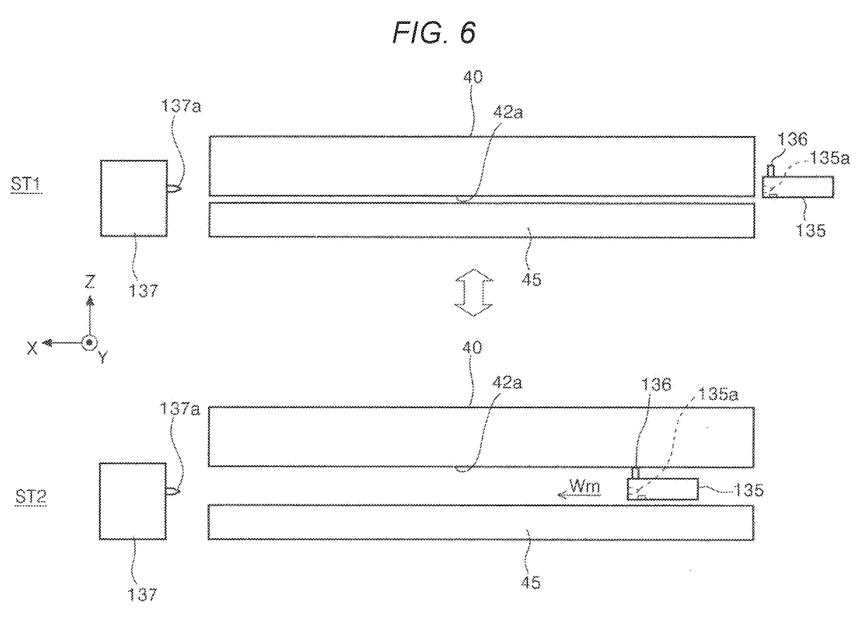

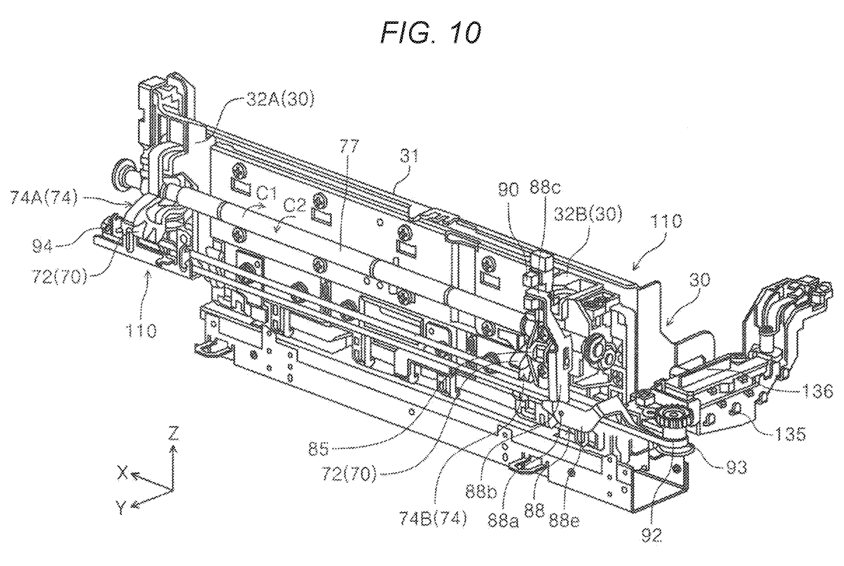

Then, the wiper 136 will be described with reference to FIGS. 6 and 10.

As illustrated in FIG. 6, the printer 1 includes a wiper carriage 135. The wiper carriage 135 is an example of a cleaning unit that cleans the head surfaces 42a by moving in the X-axis direction, that is, a direction along the head surfaces 42a of the line head 40. In the present embodiment, the wiper carriage 135 takes a position of an end portion at the -X direction side as a home position.

The wiper carriage 135 moves along the X-axis direction by the power of a wiper drive motor 129 (see FIG. 4). Here, as illustrated in FIG. 10, a driving pulley 93 is disposed at the end portion at the -X direction side, and a driven pulley 94 is disposed at an end portion at the +X direction side. A drive belt 92 is wound around the driving pulley 93 and the driven pulley 94, and the wiper carriage 135 is fixed to a part of the drive belt 92. The driving pulley 93 is rotated by the power of the wiper drive motor 129 (see FIG. 4), and thus the wiper carriage 135 moves along the X-axis direction.

The wiper carriage 135 is provided with the wiper 136. The wiper 136 is made of an elastic material such as rubber, and wipes in particular the head chips 43 (see FIG. 2) described later out of the head surfaces 42a by the wiper carriage 135 moving in the medium width direction in a state of making elastic contact with the head surfaces 42a. The ink removed by the wiping is retained in the wiper carriage 135.

In FIG. 6, a fitting hole 135a is disposed at the side surface at the +X direction side of the wiper carriage 135. A check valve (not shown) is provided to the fitting hole 135a so as to provide a configuration in which the ink retained in the wiper carriage 135 is prevented by the check from leaking.

An ink collection portion 137 is disposed at an end portion at the +X direction side in the movement area of the wiper carriage 135. The ink collection portion 137 includes a suction portion 137a, and the suction portion 137a can be fitted into the fitting hole 135a of the wiper carriage 135. When the wiper carriage 135 is moved to the end portion at the +X direction side, the suction portion 137a is fitted into the fitting hole 135a. When the suction portion 137a is fitted into the fitting hole 135a, the check valve opens. In this state, by driving a pump (not shown) provided to the ink collection portion 137, the ink retained in the wiper carriage 135 is suctioned.

The state ST1 in FIG. 6 shows a state where the line head 40 is located at the recording position. When wiping the head surfaces 42a with the wiper 136 in this state, the line head 40 is raised as represented by a change from the state ST1 to the state ST2 in FIG. 6. The position of the line head 40 at this time is the wiping position Hp3 (see FIG. 4) described above.

Accordingly, a gap into which the wiper carriage 135 enters is formed between the line head 40 and the opposed portion 45, and the wiper 136 can be brought into contact with the head surface 42a.

In this state, by moving the wiper carriage 135 in such a manner as indicated by the arrow Wm, the wiper 136 wipes the head surfaces 42a.

Note that, when the wiper 136 moves to the end portion at the -X direction side, that is, when the wiper 136 wipes the head surfaces 42a, the wiper carriage 135 moves in the -X direction to return to the home position at the end portion at the +X direction side. Prior to this operation, the line head 40 may be slightly raised to prevent the wiper 136 from coming into contact with the head surfaces 42a.

### Configuration of Moving Device for Moving Line Head

Then, the moving device 110 that converts the power of the head moving motor 101 (see FIG. 4) into an operation in the Z-axis direction of the line head 40 will be described.

First, the position in the Z-axis direction of the line head 40 can be figured out by the controller 100 based on detection information transmitted from a rotary encoder 103 (see FIG. 4) and detection information transmitted from a linear encoder 107 (see FIG. 4). Note that the term "encoder" will hereinafter be described with an abbreviation as "ENC".

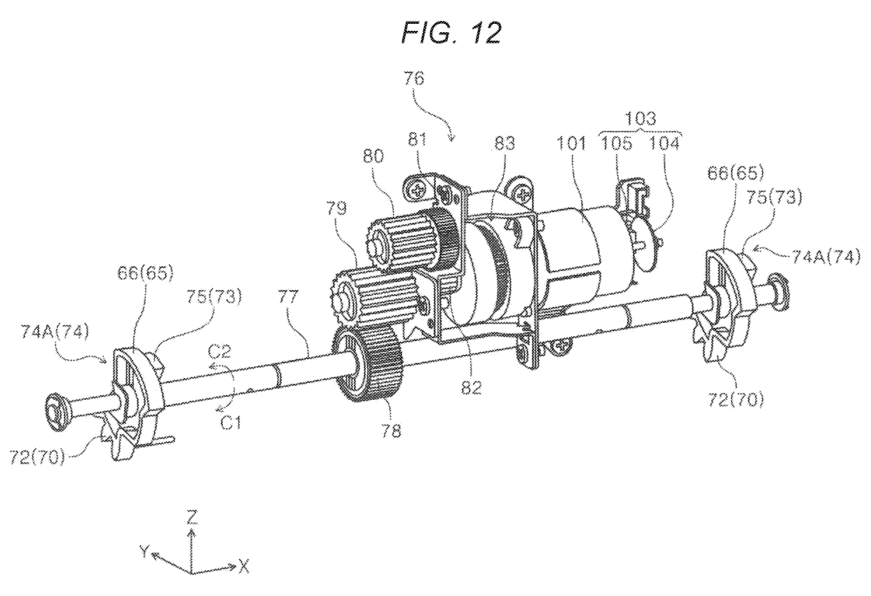

As shown in FIG. 12, the rotary ENC 103 is configured with a rotary scale 104 provided to a motor output shaft of the head moving motor 101 and a second detector 105 that detects a rotation of the rotary scale 104. The rotary ENC 103 detects the light transmissive scale of the rotary scale 104 and outputs a detection pulse signal including a proportional number of pulses to a rotation amount of the motor output shaft.

Further, the linear ENC 107 is configured with a linear scale (not shown) provided to a guide frame 33 described later and a detector (not shown) that detects movement of the linear scale. The linear ENC 107 detects a light transmissive scale of the linear scale and outputs a detection pulse signal including a proportional number of pulses to a movement amount of the head unit 30.

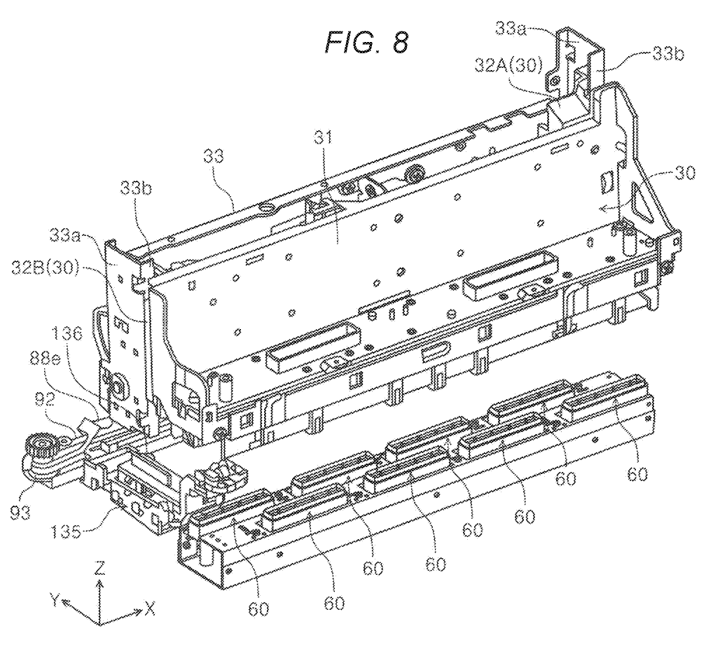

As described above, the head unit 30 including the line head 40 includes the unit frame 31 as a base body, and the line head 40 is provided to the unit frame 31 as shown in FIGS. 7 and 8.

Rack members 32 are disposed in an end portion at the +X direction side and an end portion at the -X direction side in the unit frame 31. In the unit frame 31, the rack member 32 disposed in the end portion at the +X direction side is denoted by a reference symbol 32A, and the rack member 32 disposed in the end portion at the -X direction side is denoted by a reference symbol 32B. Hereinafter, the rack members 32A, 32B are collectively referred to as the rack members 32 when there is no need to distinguish the rack members 32A, 32B from each other.

The guide frame 33 is disposed at the +Y direction side with respect to the unit frame 31. In the guide frame 33, first guide portions 33a are formed in the end portion at the +X direction side and the end portion at the -X direction side. The first guide portion 33a is a region that forms a surface parallel to the Y-Z plane. Further, a second guide portion 33b is formed in an end portion at the -Y direction side of the first guide portion 33a. The second guide portion 33b is a region that forms a surface parallel to the X-Z plane.

Although not illustrated, the rack member 32 is provided with a region that sandwiches the second guide portion 33b of the guide frame 33 in the Y-axis direction, and thus the unit frame 31, that is, the head unit 30 is guided in the Z-axis direction by the guide frame 33.

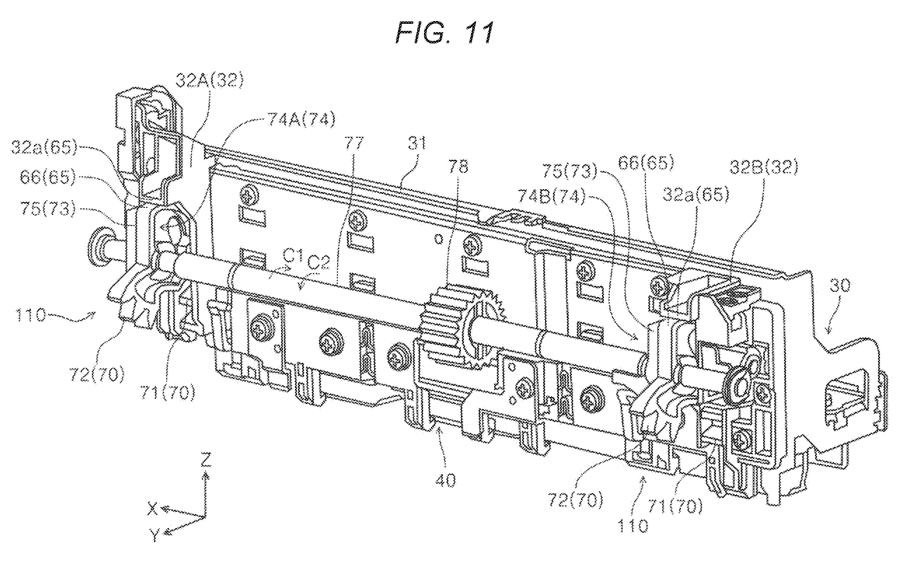

Then, as shown in FIGS. 10 and 11, a shaft 77 parallel to the X-axis direction is rotatably supported by the guide frame 33. In the shaft 77, rotating bodies 74 are disposed near an end portion at the +X direction side and near an end portion at the -X direction side. In the shaft 77, the rotating body 74 disposed near the end portion at the +X direction side is denoted by a reference symbol 74A, and the rotating body 74 disposed near the end portion at the -X direction side is denoted by a reference symbol 74B. Hereinafter, the rotating bodies 74A, 74B are collectively referred to as the rotating bodies 74 when there is no need to distinguish the rotating bodies 74A, 74B from each other.

The rotating bodies 74 rotates integrally with the shaft 77. Note that rotational directions of the shaft 77, the rotating bodies 74, and a pinion 72, a cam 66, and a press-down portion 75 described later will hereinafter be expressed using reference symbols C1, C2 shown in the drawings in some cases.

As illustrated in FIG. 12, a gear 78 is disposed between the rotating body 74A and the rotating body 74B in the shaft 77. The gear 78 rotates integrally with the shaft 77. The gear 78 constitutes a reduction mechanism 76 that transmits the power from the head moving motor 101 to the shaft 77.

Hereinafter, the reduction mechanism 76 will be described with reference to FIG. 12.

The reduction mechanism 76 includes the gear 78, a gear 79, a gear 80, a gear 81, a gear 82, and a mechanical paradox planetary gear mechanism 83.

The gear 79 meshes with the gear 78. The gear 80 meshes with the gear 79. The gear 80 and the gear 81 are integrally configured and rotate integrally. The gear 82 meshes with the gear 81. The gear 82 is an output gear of the mechanical paradox planetary gear mechanism 83.

The mechanical paradox planetary gear mechanism 83 is a known mechanical paradox planetary gear mechanism, and realizes a high reduction ratio when power is transmitted from the head moving motor 101 to the shaft 77 and a self-lock function. The self-lock function mentioned here is a function of inhibiting the rotation of the shaft 77 even when external force of urging the shaft 77 to rotate is applied. The head moving motor 101 transmits the power to the mechanical paradox planetary gear mechanism 83.

When the head moving motor 101 rotates as described above, the rotation is transmitted to the shaft 77 via the reduction mechanism 76, and the shaft 77 rotates.

Note that in the present embodiment, the reduction ratio of the reduction mechanism 76, specifically, the reduction ratio of the power transmission from the head moving motor 101 to the shaft 77 is preferably higher than 1, more preferably higher than 10, and even more preferably higher than 100. In the present embodiment, the reduction ratio is no lower than 100, and is, for example, 110.

Note that the mechanical paradox planetary gear mechanism 83 may be omitted, and a self-lock function may be realized and a high reduction ratio may be obtained by a worm gear mechanism or the like.

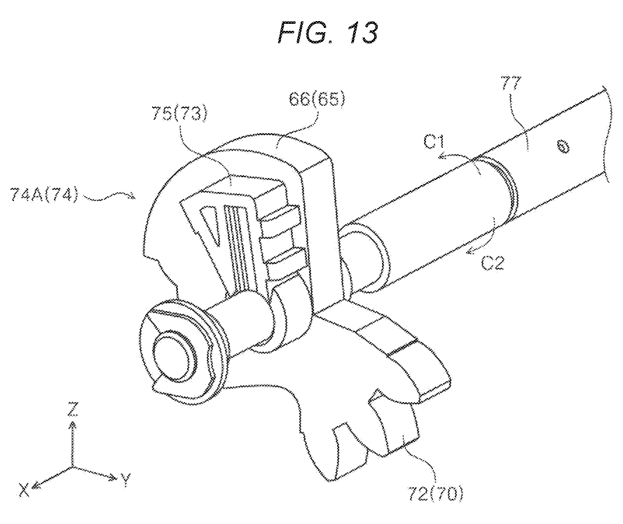

Then, the rotating body 74 is provided with the pinion 72 constituting a rack-and-pinion mechanism as shown in FIG. 13. Further, the rotating body 74 is provided with the cam 66. In addition, the rotating body 74 is provided with the press-down portion 75 shaped like a lever.

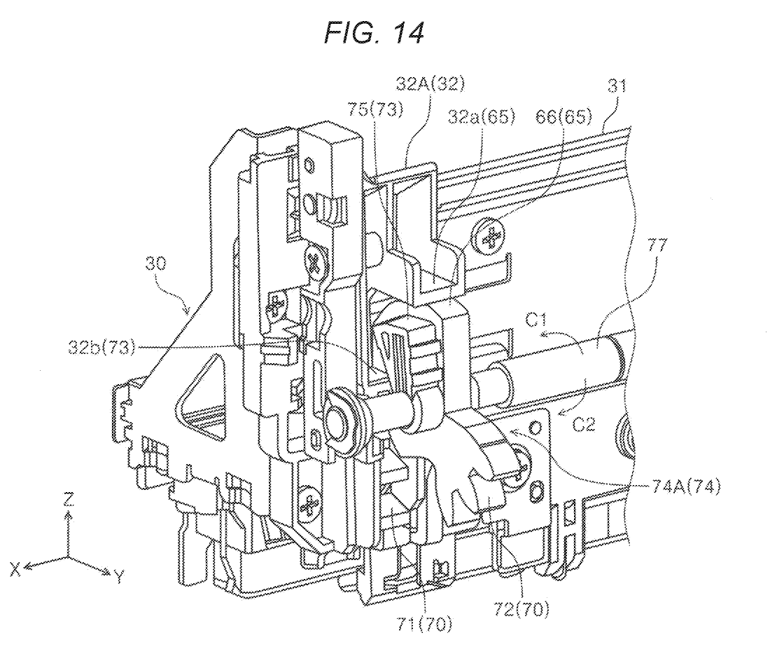

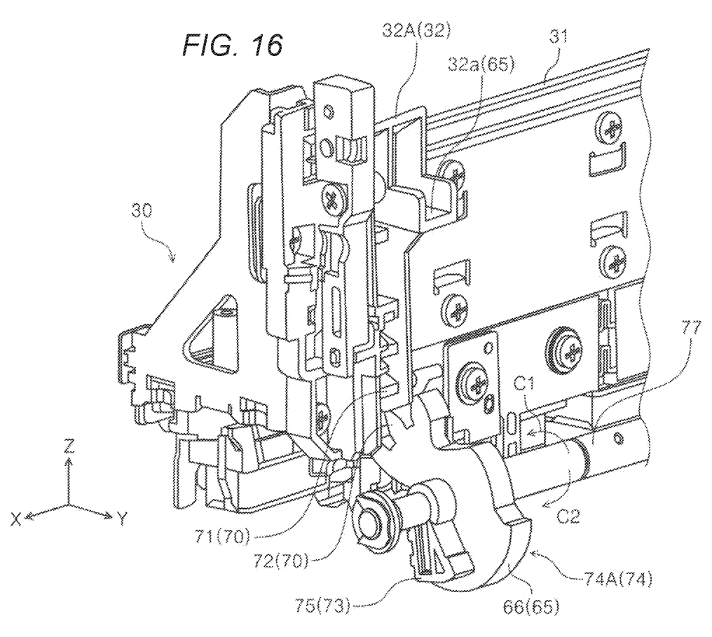

As shown in FIGS. 14 - 17, a rack 71 constituting a rack-and-pinion mechanism is provided to the rack member 32. The rack 71 meshes with the pinion 72 as illustrated in FIG. 16. Therefore, when the pinion 72 rotates, the head unit 30, that is, the line head 40 moves in the Z-axis direction. Specifically, when the pinion 72 rotates in the rotational direction C1, the line head 40 is lowered, and when the pinion 72 rotates in the rotational direction C2, the line head 40 is raised.

The rack 71 and the pinion 72 constitute a second moving section 70 (see FIG. 4) that moves the line head 40 in the second area Am2 (see FIG. 4).

Note that, since the second moving section 70 raises and lowers the line head 40 with the rack-and-pinion mechanism, the operation of raising and lowering the line head 40 with the second moving section 70 is hereinafter referred to as "rack-and-pinion drive" in some cases.

Further, as shown in FIGS. 11, 14 to 17, the rack member 32 is provided with a contact portion 32a that can come into contact with the cam 66. The contact portion 32a is disposed so as to protrude toward the +Y direction, and the rotating body 74 is disposed below the contact portion 32a. The position in the Z-axis direction of the head unit 30, that is, the line head 40 is defined by being supported by the cam 66 via the contact portion 32a as illustrated in FIG. 14 in the first area Am1 (see FIG. 4). In other words, the head unit 30, that is, the line head 40, can be placed on the cam 66 using its own weight. Note that, the head unit 30, that is, the line head 40, may be placed on the cam 66 only by its own weight, or may be placed on the cam 66 by receiving pressing force in a direction including a vertically downward component from a spring or the like. When the head unit 30, that is, the line head 40, is placed on the cam 66 by receiving the pressing force in the direction including the vertically downward component from the spring or the like, the head unit 30, that is, the line head 40, is prevented from rising up, and the platen gap is stabilized.

An outer peripheral surface of the cam 66 is formed such that a distance from a shaft center, that is, a radius of the shaft 77 changes along the circumferential direction. Therefore, when the cam 66 rotates in a state where the contact portion 32a is placed on the cam 66, the head unit 30, that is, the line head 40 moves in the Z-axis direction. Specifically, when the cam 66 rotates in the rotational direction C1, the line head 40 is lowered, and when the cam 66 rotates in the rotational direction C2, the line head 40 is raised.

The cam 66 and the contact portion 32a constitute a first moving section 65 (see FIG. 4) that moves the line head 40 in the first area Am1.

Note that, since the first moving section 65 raises and lowers the line head 40 with the cam 66, the operation of raising and lowering the line head 40 with the first moving section 65 is hereinafter referred to as "cam drive" in some cases.

The first moving section 65 and the second moving section 70 described above constitute the moving device 110 (see FIG. 4).

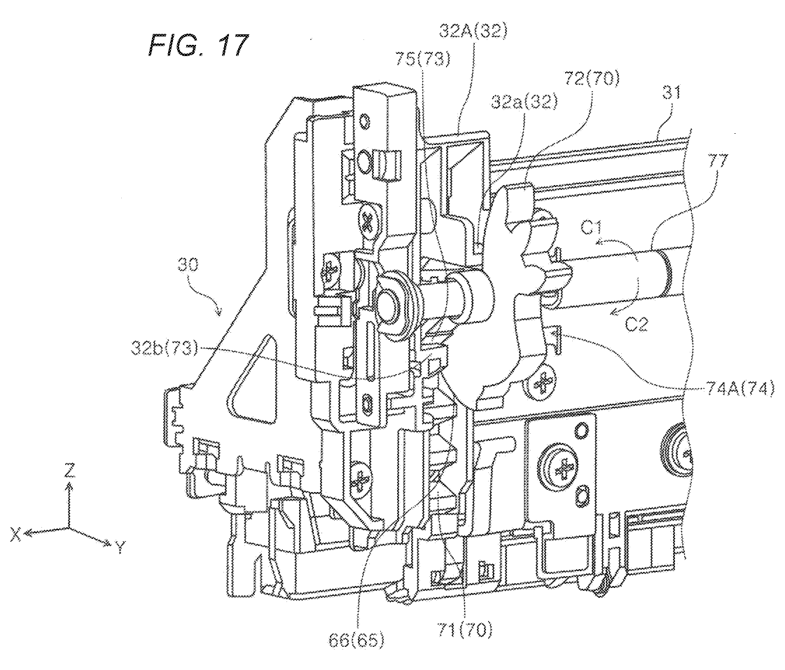

Further, as illustrated in FIGS. 14 to 17, the rack member 32 is provided with a pressed portion 32b capable of coming into contact with the press-down portion 75, and as illustrated in FIG. 17, the press-down portion 75 is configured to be able to come into contact with the pressed portion 32b from above.

When the rotating body 74 rotates in the rotational direction C1, the press-down portion 75 presses the pressed portion 32b from above, and can press down the head unit 30, that is, the line head 40, in the -Z direction, that is, downward. The press-down portion 75 and the pressed portion 32b constitute a third moving section 73 (see FIG. 4) that lowers the line head 40 in the third area Am3 (see FIG. 4).

Note that, since the third moving section 73 raises and lowers the line head 40 with the press-down portion 75 shaped like a lever, the operation of raising and lowering the line head 40 with the third moving section 73 is hereinafter referred to as "lever drive" in some cases.

In the present embodiment, the third moving section 73 constitutes the moving device 110 (see FIG. 4).

Hereinafter, the operations of the first moving section 65, the second moving section 70, and the third moving section 73 will be further described.

FIG. 14 illustrates a state in which the line head 40 is in the first area Am1. In this state, the first moving section 65 functions. That is, the head unit 30 is in a state of being placed on the cam 66 using its own weight. In this state, the rack 71 is not meshed with the pinion 72, and the press-down portion 75 is separated from the pressed portion 32b.

In the first area Am1, that is, an area where recording is performed on the medium, since it is necessary to accurately position the line head 40, the cam drive with the first moving section 65 is adopted.

When the shaft 77 rotates in the rotational direction C2 in the state in FIG. 14, the cam 66 also rotates in the rotational direction C2.

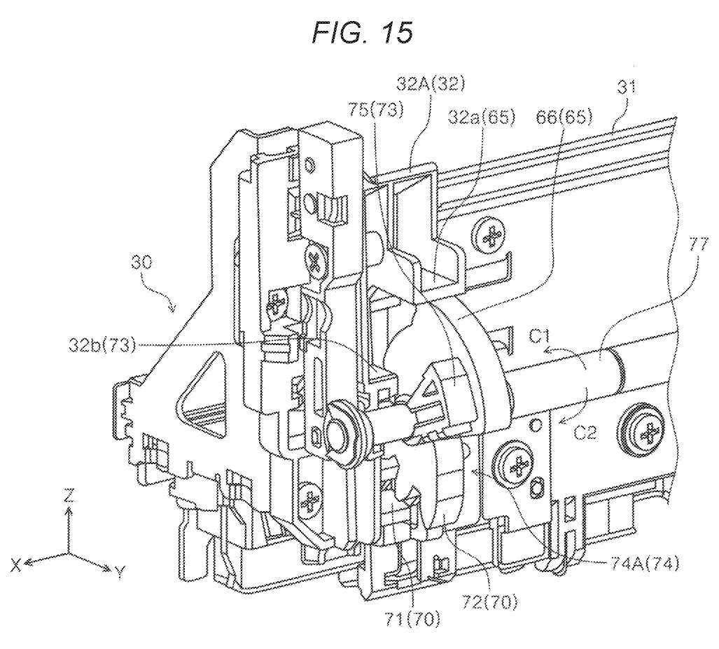

FIG. 15 illustrates a state in which the shaft 77 rotates in the rotational direction C2 in the state of FIG. 14.

Note that when the line head 40 is lowered in the state of FIG. 15 to be positioned at the cap position Hp0 (see FIG. 4), the shaft 77 is rotated in the rotational direction C1.

The state shown in FIG. 15 is a state where the contact portion 32a is placed on a region where the radius of the cam 66 is the largest, and when the shaft 77 further rotates in the rotational direction C2 in this state, the contact portion 32a is separated from the cam 66.

This state corresponds to a state in which the rack 71 starts to engage with the pinion 72.

In this way, when the line head 40 makes the transition from the first area Am1 to the second area Am2, the transition from a state of being moved by the first moving section 65 to a state of being moved by the second moving section 70 is made.

Note that when making the transition from the cam drive with the first moving section 65 to the rack-and-pinion drive with the second moving section 70, a state where the cam 66 is in contact with the contact portion 32a, that is, the line head 40, and the pinion 72 meshes with the rack 71 is temporarily achieved. Accordingly, even when the contact portion 32a is separated from the cam 66, the separation does not cause the line head 40 to be lowered.

FIG. 16 shows a state where the shaft 77 further rotates in the rotational direction C2 in the state in FIG. 15 and the head unit 30 is raised to a position at the extreme +Z direction side by the second moving section 70, that is, the rack-and-pinion mechanism. This state corresponds to a state where the line head 40 is the farthest from the opposed portion 45, and is the jam handling position Hp2 (see FIG. 4) when a paper jam occurs.

Note that the second moving section 70 is extremely larger than the first moving section 65 in the movement amount of the line head 40 per unit rotation angle of the shaft 77.

In the above process, that is, in the process of raising the line head 40 from the first area Am1 to the jam handling position, the shaft 77 is rotated in the rotational direction C2, and it is not necessary to switch the rotational direction.

Note that, in the movement area of the line head 40, the lowermost position is the cap position Hp0, and the uppermost position is the jam handling position Hp2. Similarly, in the process of raising the line head 40 from the cap position Hp0 to the jam handling position Hp2, the shaft 77 is rotated in the rotational direction C2 and it is not necessary to switch the rotational direction.

Note that, when lowering the line head 40 from the jam handling position Hp2, things are reversed from the above. That is, when the line head 40 makes the transition from the second area Am2 to the first area Am1, the transition from the rack-and-pinion drive with the second moving section 70 to the cam drive with the first moving section 65 is made. Specifically, when the line head 40 makes the transition from the second area Am2 to the first area Am1, a state in which the pinion 72 is separated from the rack 71, and the contact portion 32a is placed on the cam 66 is achieved.

Then, in the process of lowering the line head 40 from the jam handling position Hp2 to the first area Am1, the shaft 77 is rotated in the rotational direction C1 and it is not necessary to switch the rotational direction. Similarly, in the process of lowering the line head 40 from the jam handling position Hp2 to the cap position Hp0, the shaft 77 is rotated in the rotational direction C1 and it is not necessary to switch the rotational direction.

In addition, when making the transition from the rack-and-pinion drive with the second moving section 70 to the cam drive with the first moving section 65, the state where the cam 66 is in contact with the contact portion 32a, that is, the line head 40, and the pinion 72 meshes with the rack 71 is temporarily achieved. Accordingly, even when the pinion 72 is separated from the rack 71, the separation does not cause the line head 40 to be lowered.

Then, when lowering the line head 40 from the first area Am1, that is, when the capping operation is performed will be described. Note that, when performing the capping operation, when the shutter 47 (see FIG. 5) provided to the opposed portion 45 is located at the blocking position, the shutter 47 is moved from the blocking position to the open position as described above prior to the capping operation.

When performing the capping operation in the state in FIG. 14, the shutter 47 is opened and the shaft 77 is rotated in the rotational direction C1. Accordingly, the line head 40 is lowered.

When the line head 40 is lowered, the cam 66 is separated from the contact portion 32a, whereby there is achieved a state in which the head surfaces 42a of the line head 40 come into contact with the cap portions 61, and the head unit 30 is placed on the cap portions 61 by its own weight.

When the shaft 77 further rotates in the rotational direction C1 in this state, the press-down portion 75 comes into contact with the pressed portion 32b to press down the pressed portion 32b downward. That is, the lever drive with the third moving section 73 is started, and accordingly, the head unit 30, that is, the line head 40, is lowered. At this time, the head unit 30 presses down the cap portions 61 downward against the pressing force of the cap springs 63 (see FIG. 3).

FIG. 17 shows a state where the line head 40 is at the cap position Hp0. In the process in which the line head 40 moves to the cap position Hp0, the head surfaces 42a of the line head 40 come into contact with the cap portions 61, and the head surfaces 42a further press down the cap portions 61 by a predetermined amount against the pressing force from the cap springs 63. Accordingly, the cap portions 61 come into close contact with the head surfaces 42a.

When raising the head unit 30, that is, the line head 40 in the state in FIG. 17, the shaft 77 is rotated in the rotational direction C2. Accordingly, since the press-down portion 75 is displaced upward, the line head 40 is raised by the pressing force of the cap springs 63 while the position in the Z-axis direction is regulated by the press-down portion 75, and then the cam 66 comes into contact with the contact portion 32a to cause switching to the cam drive with the first moving section 65.

As described above, the line head 40 includes the rack member 32 in which the pressed portion 32b, the contact portion 32a, and the rack 71 are integrally formed. This makes it easy to determine a relative positional relationship among the pressed portion 32b, the contact portion 32a, and the rack 71.

As described above, the first moving section 65 and the second moving section 70 are driven by the head moving motor 101 which is a common driving source. Accordingly, compared to a configuration in which the first moving section 65 and the second moving section 70 are driven by separate drive sources, an increase in cost of the apparatus can be prevented, and further, the reduction in size of the apparatus can be achieved.

Further, in the present embodiment, in addition to the first moving section 65 and the second moving section 70, the third moving section 73 is driven by the single head moving motor 101. As a result, an increase in cost of the apparatus can be prevented, and the reduction in size of the apparatus can be achieved.

However, the first moving section 65 is not limited to the cam drive, and may adopt other configurations such as the rack-and-pinion drive. In addition, the second moving section 70 is not limited to the rack-and-pinion drive, and may adopt other configurations such as the cam drive.

In addition, in the present embodiment, the cam 66 and the pinion 72 are integrally formed to constitute the rotating body 74. Accordingly, the power can be easily transmitted from the head moving motor 101 to the first moving section 65 and the second moving section 70. In addition, since it is not necessary to transmit the power from the head moving motor 101 individually to the first moving section 65 and the second moving section 70, the number of parts can be reduced. As a result, an increase in cost of the apparatus can be prevented, and the reduction in size of the apparatus can be achieved.

However, the cam 66 and the pinion 72 may be formed separately.

Further, in the present embodiment, the rotating body 74 is provided with the press-down portion 75. Accordingly, the power can be easily transmitted from the head moving motor 101 to the first moving section 65, the second moving section 70, and the third moving section 73. In addition, since it is not necessary to transmit the power from the head moving motor 101 individually to the first moving section 65, the second moving section 70, and the third moving section 73, the number of parts can be reduced. As a result, an increase in cost of the apparatus can be prevented, and the reduction in size of the apparatus can be achieved.

However, the press-down portion 75 may be formed separately from the rotating body 74.

Further, in the present embodiment, when making the transition from the cam drive to the rack-and-pinion drive, and when making the transition from the rack-and-pinion drive to the cam drive, a state in which the cam 66 is in contact with the line head 40 and the pinion 72 meshes with the rack 71 is temporarily achieved. Accordingly, a state where the line head 40 is supported by neither the cam 66 nor the pinion 72 is prevented from occurring. As a result, it is possible to avoid the occurrence of a failure in which the line head 40 falls down and the line head 40 is damaged due to the impact.

In addition, when the cam 66 and the pinion 72 are separately formed, there is a concern that the state where the cam 66 is in contact with the line head 40 and the pinion 72 meshes with the rack 71 cannot be temporarily achieved due to a component tolerance, an assembly error, and so on. However, in the present embodiment, since the cam 66 and the pinion 72 are integrally formed, it is possible to prevent the occurrence of such a problem as described above.

In addition, in the present embodiment, the line head 40 includes the rack member 32 in which the contact portion 32a that comes into contact with the cam 66 and the rack 71 are integrally formed. This makes it easy to determine the positional relationship between the contact portion 32a and the rack 71.

Here, supposedly, when the contact portion 32a and the rack 71 are separately formed, there is a concern that the state where the cam 66 is in contact with the line head 40 and the pinion 72 meshes with the rack 71 cannot be temporarily achieved due to the component tolerance, the assembly error, and so on. However, since the contact portion 32a and the rack 71 are integrally formed and the positional relationship between the contact portion 32a and the rack 71 is easily determined, it is possible to prevent the occurrence of the problem described above.

In addition, in the present embodiment, the printer 1 includes the guide frame 33 which guides the line head 40 in the X-axis direction, that is, a moving direction of the line head 40, and the shaft 77 which is a rotary shaft of the rotating body 74, and the shaft 77 is rotatably supported by the guide frame 33. Accordingly, the positional relationship between the rotating body 74 and the rack member 32 is easily determined, the positional relationship between the rack 71 and the pinion 72 is appropriately determined, and the positional relationship between the contact portion 32a and the cam 66 is also appropriately determined. Therefore, the line head 40 can be appropriately moved by the first moving section 65 and the second moving section 70.

Further, in the present embodiment, the rotating body 74 is provided with the press-down portion 75 that presses down the line head 40 toward the cap portions 61 due to the rotation of the rotating body 74 after the contact between the contact portion 32a that comes into contact with the cam 66 in the line head 40 and the cam 66 is released. Accordingly, the following functions and advantages can be obtained.

In order to achieve the state in which the head surfaces 42a of the line head 40 are reliably covered with the cap portions 61, it is necessary to press the head surfaces 42a against the cap portions 61 against the pressing force of the cap springs 63. The first moving section 65 moves the line head 40 in the first area Am1 and moves the line head 40 with the rotation of the cam 66, but cannot press the head surfaces 42a against the cap portions 61.

However, the rotating body 74 is provided with the press-down portion 75 that presses down the line head 40 toward the cap portions 61 due to the rotation of the rotating body 74 after the contact between the contact portion 32a that comes into contact with the cam 66 in the line head 40 and the cam 66 is released. Accordingly, the head surfaces 42a can be reliably pressed against the cap portions 61, and the head surfaces 42a can be reliably covered with the cap portions 61.

In addition, since the press-down portion 75 is provided to the rotating body 74, a separate power source for reliably pressing the head surfaces 42a against the cap portions 61 is not required. As a result, an increase in cost of the apparatus can be prevented, and the reduction in size of the apparatus can be achieved.

Further, in the rotating body 74 according to the present embodiment, the cam 66 and the pinion 72 overlap each other in an axial direction, that is, the X-axis direction. In other words, at least a part of the cam 66 and at least a part of the pinion 72 are located at the same position in the X-axis direction. In still other words, the cam 66 and the pinion 72 are arranged along a circumferential direction of the rotating body 74.

Due to such a configuration, a size in the X-axis direction of the rotating body 74 can be reduced, and by extension, the reduction in size of the apparatus can be achieved.

In addition, in the present embodiment, the thickness of the cam 66 and the thickness of the pinion 72 in the X-axis direction are the same, and a formation area of the cam 66 and a formation area of the pinion 72 coincide with each other in the X-axis direction. Accordingly, the size in the X-axis direction of the rotating body 74 can be further reduced, and by extension, the reduction in size of the apparatus can further be achieved.

However, a configuration in which a part of the cam 66 and a part of the pinion 72 overlap each other in the X-axis direction may be adopted. In addition, the thickness of the cam 66 may be different from the thickness of the pinion 72.

Further, in the rack member 32, the contact portion 32a and the rack 71 overlap each other in the X-axis direction so as to correspond to the arrangement of the cam 66 and the pinion 72 described above. In other words, at least a part of the contact portion 32a and at least a part of the rack 71 are located at the same position in the X-axis direction. Due to such a configuration, the size of the rack member 32 in the X-axis direction can be reduced, and by extension, the size of the apparatus can be reduced.

### Control System of Printer

Then, a control system of the printer 1 and position detection in the moving direction of the line head 40 will generally be described. Hereinafter, when simply referred to as a moving direction, it means the moving direction (Z-axis direction) of the line head 40.

Note that, the controller 100 shown in FIG. 4 performs overall control of the printer 1, but configurations not related to the movement of the line head 40 are not illustrated in FIG. 4.

The controller 100 performs various types of control including recording control of the printer 1. The controller 100 includes one or more processors that operate according to a computer program, in other words, software. The processor includes a CPU and a memory such as a RAM and a ROM, and the memory stores program codes or commands configured to cause the CPU to execute processing. The controller 100 is not limited to what performs software processing. For example, the controller 100 may include a dedicated hardware circuit such as an application specific integrated circuit (ASIC) that performs hardware processing for at least a part of processing to be executed by itself.

The head moving motor 101 and the wiper drive motor 129 are electrically coupled to the controller 100 as an output system. In the present embodiment, the motors are DC motors, and are subjected to pulse width modulation (PWM) control by the controller 100.

In addition, an operation unit 115, the rotary ENC 103, the linear ENC 107, and a detector 90 are electrically coupled to the controller 100 as an input system. The operation unit 115 is a region that receives ON/OFF of the power of the printer 1, various settings, and recording execution, and can be implemented by, for example, a touch panel in which a user interface is realized by control of the controller 100.

The controller 100 includes a calculation unit 120, a motor controller 121, a motor driver 122, a volatile memory 123, and a nonvolatile memory 124 which is an example of a storage device. Further, the controller 100 includes a motor controller 127 and a motor driver 128.

The calculation unit 120 performs various calculations necessary for operating the printer 1. For example, the calculation unit 120 calculates various setting values necessary for executing a program 125 stored in the nonvolatile memory 124. The volatile memory 123 is used as a temporary data saving area.

The motor controller 121 controls the head moving motor 101 via the motor driver 122 by outputting, to the motor driver 122, a current command value, for example, a duty signal necessary for the pulse width modulation (PWM) control. The motor driver 122 includes a D/A converter, and controls a current supplied to the head moving motor 101 by performing the PWM control based on the duty signal.

In the present embodiment, the motor controller 121 performs PID control on the head moving motor 101. The motor controller 121 calculates a target rotational velocity by multiplying, by a gain Kp, a position error between a target rotational position of the head moving motor 101 and an actual rotational position obtained from an output signal from the rotary ENC 103. Then, the motor controller 121 calculates a proportional component, an integral component, and a differential component using a proportional element, an integral element, and a differential element based on a velocity error between a target rotational velocity and an actual rotational velocity obtained from the output from the rotary ENC 103, and sends the duty signal to the motor driver 122 based on a sum of these calculation results.

Note that, the motor controller 121 may control the head moving motor 101 based on an output signal from the linear ENC instead of the output signal from the rotary ENC 103.

The calculation unit 120 detects an edge of an output pulse of the rotary ENC 103, counts the number thereof, and calculates the rotational position of the head moving motor 101 based on the count value. The calculation unit 120 distinguishes forward rotation and reverse rotation of the head moving motor 101 based on comparison processing of two pulse signals output from the rotary ENC 103. Then, when one edge is detected, the calculation unit 120 performs counting processing so as to perform increment and decrement of the rotational position of the head moving motor 101 in accordance with the forward rotation and the reverse rotation.

Note that, the rotary ENC 103 outputs the two pulse signals, that is, a pulse ENC-A and a pulse ENC-B. In any of the forward rotation and the reverse rotation of the head moving motor 101, the phases of the pulse ENC-A and the pulse ENC-B are shifted by 90 degrees from each other. When the head moving motor 101 is in the forward rotation, the pulse ENC-A leads in phase by 90 degrees from the pulse ENC-B. In contrast, when the head moving motor 101 is in the reverse rotation, the pulse ENC-A lags in phase by 90 degrees from the pulse ENC-B. A period of the pulses is equal to time it takes for the head moving motor 101 to rotate by an interval between slits of the rotary scale 104. Accordingly, the calculation unit 120 can detect the rotational velocity of the head moving motor 101.

Note that, the calculation unit 120 can calculate the movement amount of the line head 40 based on a rotation amount of the head moving motor 101 and the reduction ratio of the reduction mechanism 76 described above. In addition, when the calculation unit 120 detects the period of each pulse, a moving speed of the line head 40 can be calculated based on the reduction ratio of the reduction mechanism 76 described above. However, when the signal change of the linear ENC 107 is not detected, the line head 40 does not move even when the position of the rotary ENC 103 changes.

In addition, the calculation unit 120 may also detect edges of an output pulse of the linear ENC 107, count the number thereof, and calculate the position of the line head 40 in the moving direction based on the count value. The calculation unit 120 distinguishes the rising and the lowering of the line head 40 based on comparison processing of two pulse signals output from the linear ENC 107. Then, when one edge is detected, the calculation unit 120 performs counting processing so as to perform increment and decrement of the position of the line head 40 in accordance with the rising and the lowering.

Note that, the linear ENC 107 outputs the two pulse signals, that is, a pulse ENC-A and a pulse ENC-B. In any of the rising and the lowering of the line head 40, the phases of the pulse ENC-A and the pulse ENC-B are shifted by 90 degrees from each other. When the line head 40 is raised, the pulse ENC-A leads in phase by 90 degrees from the pulse ENC-B. In contrast, when the line head 40 is lowered, the pulse ENC-A lags in phase by 90 degrees from the pulse ENC-B. A period of the pulses is equal to time it takes for the line head 40 to move by an interval between slits of the linear scale 108.

When the calculation unit 120 counts the number of pulses of the pulse signal, the movement amount of the line head 40 can be detected. In addition, when the calculation unit 120 detects the period of each pulse, the moving speed of the line head 40 can be calculated.

The position in the moving direction of the line head 40 may be figured out based on the origin position of the rotary ENC 103 or may be figured out based on the origin position of the linear ENC 107. In any of the cases, distances from the origin position to boundaries of the respective areas can be stored in the nonvolatile memory 124 as known values. As a result, the controller 100 can figure out the current position of the line head 40.

The origin position in the moving direction of the line head 40 can be set based on an increase in a drive current value of the head moving motor 101 when, for example, the line head 40 is raised and the line head 40 comes into contact with a movement restriction portion (not illustrated).

Note that, in the present embodiment, due to the reduction mechanism 76, the rotary ENC 103 is higher than the linear ENC 107 in an encoder resolution with respect to a unit movement amount of the line head 40. Therefore, in order to ensure stop position accuracy of the line head 40, it is suitable to perform basic velocity control of the head moving motor 101 based on the output signals from the rotary ENC 103.

The motor controller 127 controls the wiper drive motor 129 via the motor driver 128 by outputting a current command value, for example, a duty signal necessary for the PWM control to the motor driver 128. The wiper drive motor 129 is a motor for driving the wiper carriage 135 described above.

The detector 90 will be described later again.

### Restriction Portion for Restricting Movement of Line Head

Then, a restriction portion that restricts the movement of the line head 40 will be described.

When the printer 1 is transported in a state where the line head 40 is located at the cap position Hp0 and the head surfaces 42a are covered with the cap portions 61, when vibration, impact, or the like is applied to the printer 1, the line head 40 may rise to separate the cap portions 61 from the head surfaces 42a.

In order to prevent such a problem, the printer 1 according to the present embodiment includes the restriction portion that restricts the movement, specifically, the rising of the line head 40 located at the cap position Hp0.

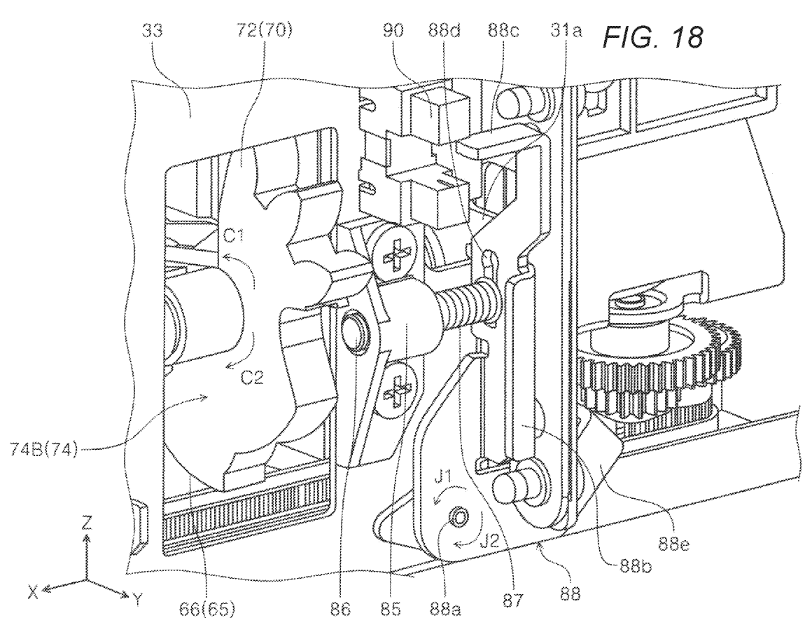

In the present embodiment, the restriction portion is configured with a pin member 86 shown in FIGS. 18 to 20 and 23 to 25. The pin member 86 is provided for the rotating body 74B in the present embodiment, but may be provided for the rotating body 74A.

As illustrated in FIGS. 18 to 20, the guide frame 33 is provided with a guide member 85. The pin member 86 is held by the guide member 85 slidably in the X-axis direction. Further, a lever member 88 is provided to the guide frame 33 so as to be swingable about a swing shaft 88a. The shaft center line of the swing shaft 88a is parallel to the Y-axis direction. Reference symbols J1, J2 indicate swing directions of the lever member 88.

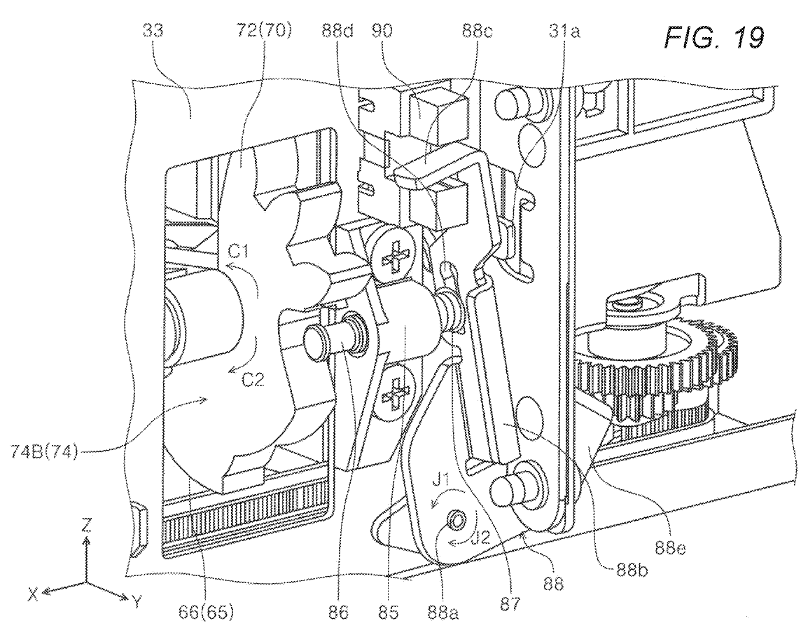

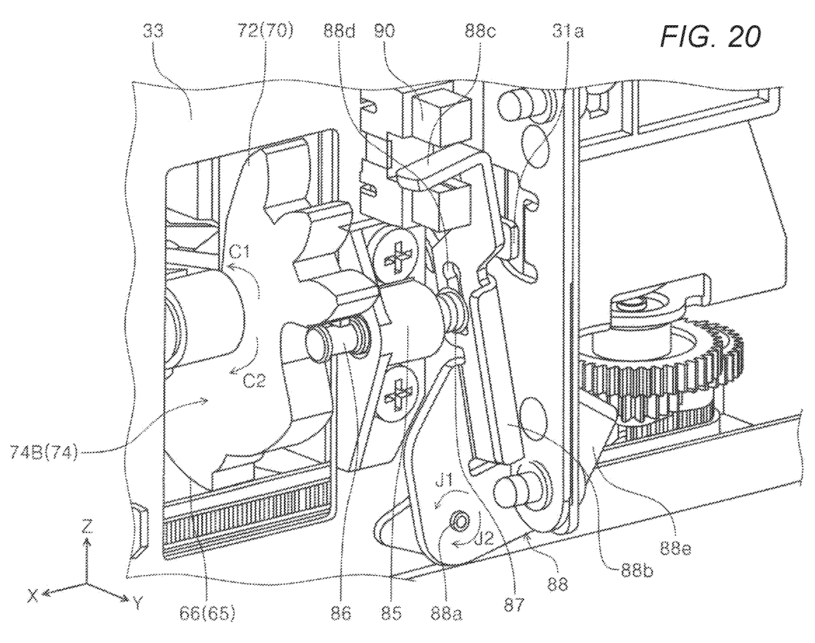

An end portion at the -X direction side of the pin member 86 can engage with a first arm portion 88b of the lever member 88. When the lever member 88 swings in the direction of the arrow J1 and the pin member 86 is pushed toward the +X direction by the first arm portion 88b, the pin member 86 advances with respect to the pinion 72 of the rotating body 74B (see FIGS. 19 and 20). When the pin member 86 advances with respect to the pinion 72, the pinion 72 cannot rotate, in particular, cannot rotate in the rotational direction C2, and the movement of the line head 40 is restricted (see FIG. 20).

FIG. 20 illustrates a state in which the movement of the line head 40 is restricted in a state in which the line head 40 is located at the cap position Hp0. Specifically, even when the rotating body 74B is about to rotate in the rotational direction C2, a tooth of the pinion 72 located closest in the rotational direction C2 comes into contact with the pin member 86, so that the rotation of the rotating body 74B in the rotational direction C2 is restricted. Since the rotational direction C2 is the rotational direction of the rotating body 74B when the line head 40 rises, the movement of the line head 40 in the rising direction is restricted.

Hereinafter, the state of the pin member 86 at this time is referred to as a restriction state in some cases.

Then, a compression coil spring 87, which is an example of a pressing member, is disposed between the first arm portion 88b of the lever member 88 and the guide member 85, and the first arm portion 88b is pressed toward the -X direction by the compression coil spring 87. That is, the lever member 88 is pressed in the swing direction J2. Therefore, when no external force is applied to the lever member 88 or when the pin member 86 is not restrained by a restraint portion described later, the first arm portion 88b is located at the movement limit in the -X direction, whereby a state where the pin member 86 is retracted from the pinion 72 is maintained (see FIG. 18). Hereinafter, the state of the pin member 86 at this time is referred to as a restriction release state in some cases.

Note that the guide frame 33 is provided with a contact portion 31a, and a movement limit in the -X direction of the first arm portion 88b is defined by the first arm portion 88b coming into contact with the contact portion 31a. In other words, a swing limit in the swing direction J2 of the lever member 88 is defined by the contact portion 31a.

Then, the lever member 88 will further be described. The lever member 88 includes the first arm portion 88b described above as a region extending from the swing shaft 88a, and further includes a second arm portion 88e as another arm portion. A detection target portion 88c is disposed at a distal end portion of the first arm portion 88b. The detector 90 is disposed above the guide member 85, and the detector 90 detects the detection target portion 88c. As illustrated in FIG. 18, in the restriction release state of the pin member 86, the detection target portion 88c is out of the optical axis of the detector 90. When the lever member 88 swings in the direction of the arrow J1 in this state, the pin member 86 takes the restriction state as shown in FIG. 19, and at this time, the detection target portion 88c blocks the optical axis of the detector 90. In this way, the controller 100 (see FIG. 4) can detect the posture of the lever member 88, and by extension, can detect the position of the pin member 86 with respect to the pinion 72, that is, can detect whether the pin member 86 is in the restriction state or the restriction release state.

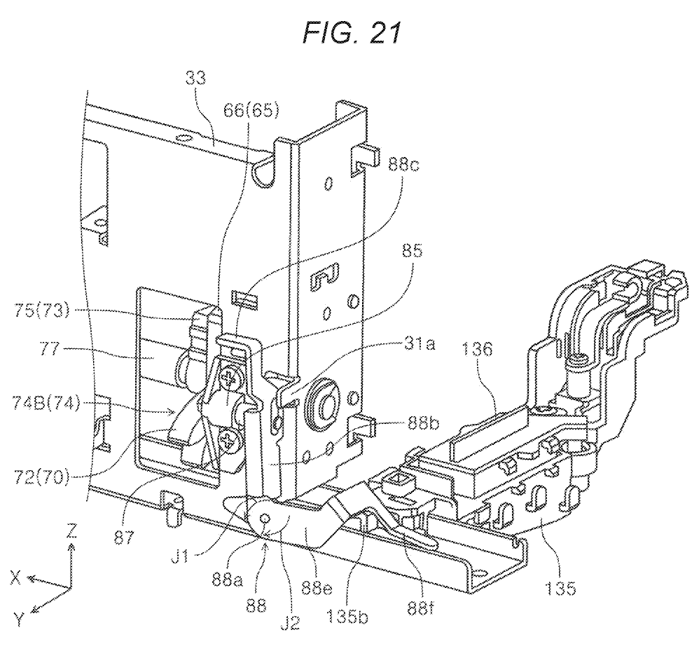

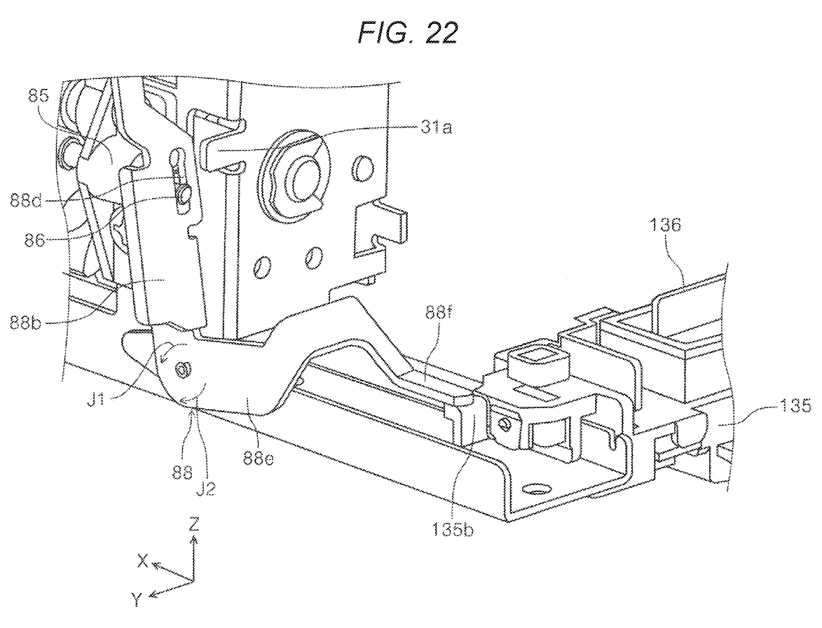

Then, the second arm portion 88e extends in the -X direction as illustrated in FIGS. 21 and 22. An engagement target portion 88f is disposed at a distal end portion of the second arm portion 88e. The wiper carriage 135 is provided with an engagement portion 135b, and the engagement target portion 88f is located at a position where the engagement target portion 88f can engage with the engagement portion 135b.

FIG. 21 illustrates a state in which the wiper carriage 135 is located at the +X direction side with respect to the end portion at the -X direction side of the movement area. In this state, the engagement portion 135b is not engaged with the engagement target portion 88f. In this state, the first arm portion 88b of the lever member 88 is in contact with the contact portion 31a, the pin member 86 is in the restriction release state, and the rotating body 74B is in a rotatable state. That is, the line head 40 is in a movable state.

When the wiper carriage 135 moves to the end portion at the -X direction side of the movement area in this state, the engagement portion 135b pushes up the engagement target portion 88f as illustrated in FIG. 22. As a result, the lever member 88 swings in the direction of the arrow J1, the pin member 86 advances to the pinion 72 to take the restriction state, and the rotating body 74B takes a non-rotatable state. That is, a state in which the movement of the line head 40 is restricted is achieved.

As described above, the printer 1 includes the pin member 86 as the restriction portion that can be switched, in accordance with the operation of the wiper carriage 135, between the restriction state (see FIG. 20) in which the movement of the line head 40 is restricted and the restriction release state (see FIG. 18) in which the movement of the line head 40 is not restricted.

Accordingly, it is possible to reliably achieve a desired purpose compared to a configuration in which the movement of the line head 40 is manually restricted or the restriction thereof is manually released. That is, when it is necessary to restrict the movement of the line head 40, the movement of the line head 40 can more reliably be restricted, and when it is necessary to allow the movement of the line head 40, the movement of the line head 40 can more reliably be allowed.

In addition, since the switching of the state of the pin member 86 is performed by the action of the wiper carriage 135, a dedicated power source for switching the state of the pin member 86 is not required, and an increase in cost and size of the apparatus can be suppressed.

Further, in the present embodiment, the movement range of the wiper carriage 135 includes an engagement position where the wiper carriage 135 engages with the pin member 86. Regarding the engagement position, a position of the wiper carriage 135 shown in FIG. 22 located on the movement path of the wiper carriage 135 is the engagement position of the wiper carriage 135. Note that the expression that the wiper carriage 135 engages with the pin member 86 has meaning including not only when the wiper carriage 135 is directly engaged with the pin member 86 but also when the wiper carriage 135 indirectly engages with the pin member 86 via another member. In the present embodiment, the wiper carriage 135 indirectly engages with the pin member 86 via the lever member 88.

Further, when the wiper carriage 135 is located at the engagement position (see FIG. 22), the pin member 86 takes the restriction state (see FIG. 20). Further, when the wiper carriage 135 is displaced from the engagement position (see FIG. 21), the pin member 86 takes the restriction release state (see FIG. 18). Due to such a configuration, it is possible to easily realize the state switching of the pin member 86 according to the action of the wiper carriage 135.

Further, in the present embodiment, the moving device 110 that moves the line head 40 includes the rotating body 74B, and the pin member 86 restricts the rotation of the rotating body 74B in the restriction state and allows the rotation of the rotating body 74B in the restriction release state. More specifically, in the present embodiment, the rotating body 74B includes the pinion 72 constituting the rack-and-pinion mechanism, and the pin member 86 advances to a position where the rotation of the pinion 72 is inhibited in the restriction state, and retracts to a position where the rotation of the pinion 72 is allowed in the restriction release state.

According to such a configuration, the restriction state of the pin member 86 can easily be achieved. In addition, compared to a configuration in which the pin member 86 directly restricts the movement of the line head 40, the movement of the line head 40 can be easily restricted with weak external force.

Further, in the present embodiment, the wiper carriage 135 linearly moves to thereby perform cleaning of the line head 40. Further, the pin member 86 advances and retreats with respect to the pinion 72 by swinging the lever member 88 that swings to thereby transmit the moving operation of the wiper carriage 135 to the pin member 86.

In this way, since the pin member 86 is configured to advance and retreat with respect to the pinion 72 by the lever member 88 swinging, the moving operation of the wiper carriage 135 can be transmitted to the pin member 86 with a simple configuration.

Note that in the present embodiment, the restriction portion that restricts the movement of the line head 40 is configured with the pin member 86, but this is not a limitation, and the restriction portion may be configured with, for example, the lever member 88, and in this case, the first arm portion 88b of the lever member 88 is configured to be able to make direct contact with the pinion 72. Alternatively, in a configuration in which the restriction portion is configured with the pin member 86, it is possible to adopt a configuration in which the pin member 86 is displaced by being directly engaged with the wiper carriage 135 without the intervention of the lever member 88.

In addition, the restriction portion which restricts the movement of the line head 40 restricts the movement of the line head 40 in accordance with the operation of the wiper carriage 135, but a configuration in which another mechanism operates due to the operation of the wiper carriage 135 to switch the state of the pin member 86 may be adopted.

Further, the cleaning unit that switches the state of the restriction portion is the wiper carriage 135 in the present embodiment, but is not limited thereto as long as the cleaning unit moves to thereby clean the cleaning target.

Then, other features of the present embodiment will be described.

An engagement region between the lever member 88 and the pin member 86 is provided with play. This play will hereinafter be described.

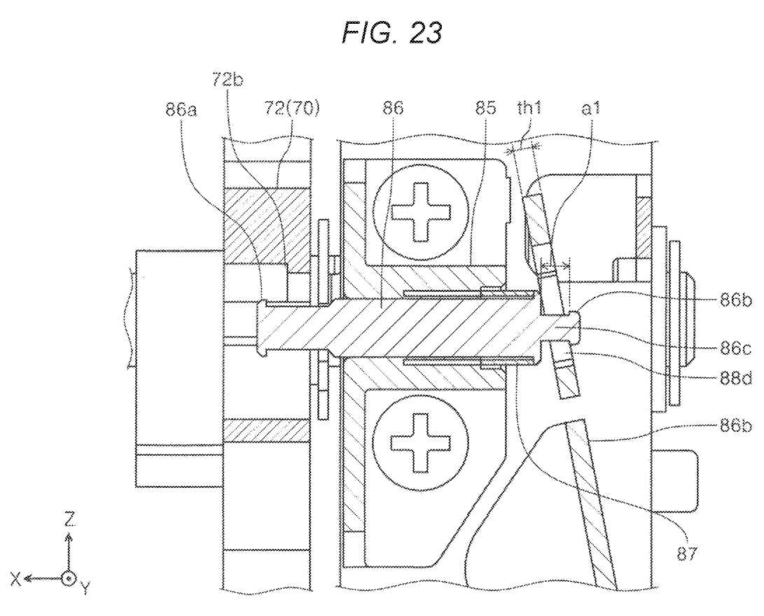

As illustrated in FIG. 23, an engagement portion 86b shaped like a flange is formed at an end portion at the -X direction side of the pin member 86. An elongated hole 88d is provided to the first arm portion 88b of the lever member 88 (see also FIGS. 18 to 20), and the engagement portion 86b is inserted through the elongated hole 88d and can be engaged with a side surface at the -X direction side of the first arm portion 88b. Accordingly, when the first arm portion 88b moves toward the -X direction due to the swing of the lever member 88, the first arm portion 88b moves the pin member 86 toward the -X direction.

In FIG. 23, a reference symbol a1 denotes the width in the X-axis direction of a region (indicated by a reference symbol 86c) of the pin member 86 that enters the elongated hole 88d, and a reference symbol th1 denotes the plate thickness of a region of the first arm portion 88b that engages with the pin member 86. The width a1 is larger than the plate thickness th1, and the difference therebetween constitutes a part of the play between the first arm portion 88b and the pin member 86. Further, the length of the elongated hole 88d is larger than the diameter of the portion (indicated by the reference symbol 86c) of the pin member 86 that enters the elongated hole 88d, and the difference therebetween constitutes a part of the play between the first arm portion 88b and the pin member 86.

As described above, since the play is provided to the engagement region between the lever member 88 and the pin member 86, it is possible to prevent the lever member 88 and the pin member 86 from restraining the mutual actions, and the swing action of the lever member 88 is smoothly converted into the linear action of the pin member 86.

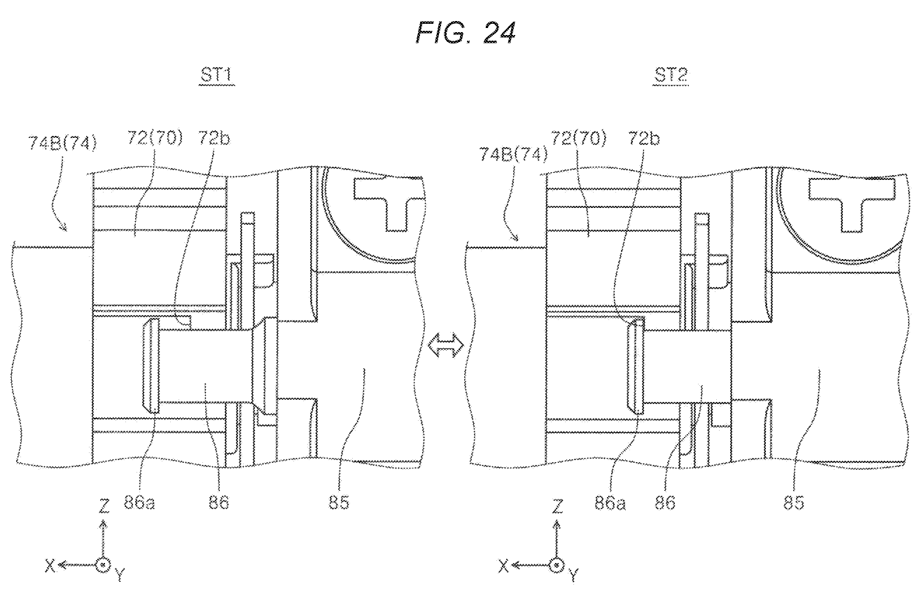

In addition, in the present embodiment, as illustrated in FIGS. 23 and 24, the pinion 72 includes a restraint portion 72b that restrains the pin member 86 so as not to move in the retracting direction in a state of being engaged with the pin member 86. That is, the restraint portion 72b restrains the pin member 86 set in the restriction state. The states ST1, ST2 in FIG. 24 are both the restriction state of the pin member 86, that is, the state in which the pinion 72 is in contact with the pin member 86, and the state in which the upward movement of the line head 40 is restricted. A restraining target portion 86a shaped like a flange is formed at the distal end at the +X direction side of the pin member 86, and the pinion 72 is provided with the restraint portion 72b that restricts the movement of the pin member 86 toward the -X direction by catching the restraining target portion 86a.

The state ST1 in FIG. 24 is a state in which the wiper carriage 135 is located at the engagement position and the pin member 86 protrudes to the extreme +X direction side. In this state, when vibration, impact, or the like is applied to the printer 1, the wiper carriage 135 may be displaced toward the +X direction from the engagement position, and there is a possibility that the lever member 88 swings to unintentionally displace the pin member 86 from the restriction state to the restriction release state.

However, in the present embodiment, since the restraint portion 72b is provided to the pinion 72 as described above, it is possible to prevent the engagement between the pinion 72 and the pin member 86 from being unintentionally released due to the vibration, impact, or the like, and to appropriately maintain the restriction state of the pin member 86.

In addition, it is possible to suppress an increase in the size of the apparatus compared to a configuration in which another lock mechanism that restricts the wiper carriage 135 so as not to move from the engagement position is provided.

Then, control of the controller 100 will be described.

FIG. 18 shows the phase of the rotating body 74 when the pin member 86 is switched from the restriction release state to the restriction state, and when the pin member 86 is switched from this state to the restriction state, the state shown in FIG. 19 is achieved. This state is a state in which the line head 40 is further slightly lowered from the cap position Hp0, and is a state in which a gap is formed between the pin member 86 and the pinion 72 so that the pin member 86 does not collide with the side surface of the pinion 72 when the pin member 86 is switched from the restriction release state to the restriction state. When switching the pin member 86 from the restriction release state to the restriction state, the controller 100 positions the rotating body 74 at the phase described above. Further, in this state, the wiper carriage 135 is moved to the engagement position to switch the pin member 86 from the restriction release state to the restriction state.

Then, the controller 100 rotates the rotating body 74 in the rotational direction C2 to bring the pinion 72 into contact with the pin member 86 as illustrated in FIGS. 20 and 24. Accordingly, the upward movement of the line head 40 is restricted. Further, accordingly, as described with reference to FIG. 24, the displacement of the pin member 86 to the restriction release position is restricted by the restraint portion 72b.

Note that the controller 100 can detect that the pinion 72 comes into contact with the pin member 86 based on an increase in the drive current value of the head moving motor 101 (see FIG. 4).

Note that when the pin member 86 is switched from the restriction state to the restriction release state, the controller 100 slightly rotates the rotating body 74 in the rotational direction C1 in the state of FIG. 20 to achieve the state shown in FIG. 19, that is, a state in which a gap is formed between the pin member 86 and the pinion 72. As a result, the restraint of the pin member 86 by the restraint portion 72b described with reference to FIG. 24 is released, and the state in which the pin member 86 can be displaced to the restriction release position is achieved. Then, in this state, the pin member 86 is switched from the restriction state to the restriction release state.

Here, for example, when the user uses the printer 1 for the first time after shipment of the printer 1, when the phase of the rotating body 74 grasped by the controller 100 is different from the actual phase, there is a possibility that the pin member 86 collides with the side surface of the pinion 72 when the pin member 86 is switched from the restriction release state to the restriction state.

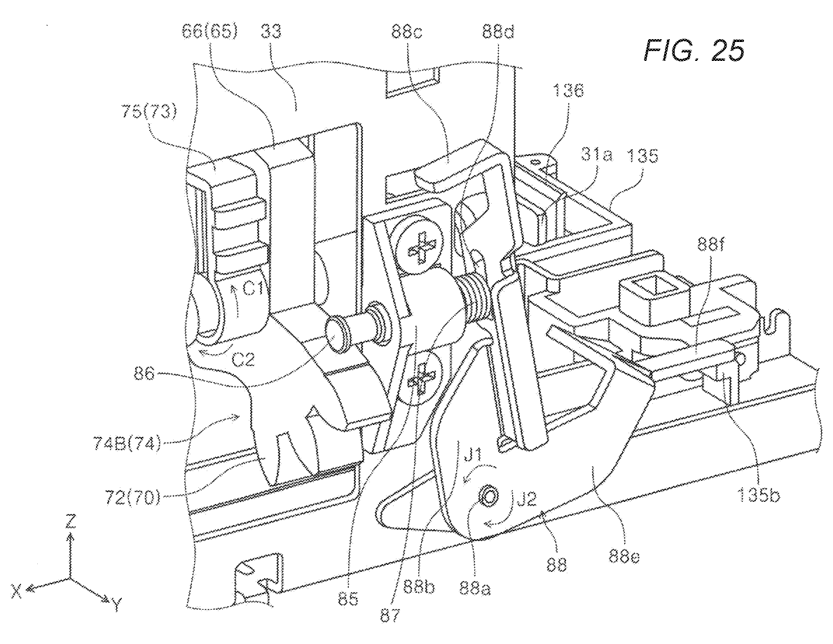

Therefore, the controller 100 performs an initialization operation when the power of the printer 1 is first turned on. FIG. 25 illustrates the phase of the rotating body 74 when the initialization operation is performed. In this state, the pin member 86 faces between the pinion 72 and the cam 66 of the rotating body 74. Since a large gap is formed between the pinion 72 and the cam 66, the pin member 86 is less likely to collide with the side surface of the pinion 72 even when the phase of the rotating body 74 is shifted to some extent. The controller 100 advances the pin member 86 in the +X direction in a state where the phase of the rotating body 74 is such a phase.

FIG. 25 shows a state in which the pin member 86 is advanced in this way. Then, in this state, the rotating body 74 is rotated in the rotational direction C1, and an increase in the drive current value of the head moving motor 101 (FIG. 4) when the pinion 72 comes into contact with the pin member 86 is detected to thereby detect the phase of the rotating body 74. Due to such an initialization operation, the rotating body 74 can be stopped at an accurate phase, and the pin member 86 can be prevented from colliding with the side surface of the pinion 72 when the pin member 86 is switched from the restriction release state to the restriction state. Such an initialization operation may be performed not only when the power of the printer 1 is first turned on but also when the power is turned on for the second time or later.

Hereinafter, the control of the controller 100 will further be described.

The controller 100 that controls the wiper carriage 135 brings the pin member 86 into the restriction state when the apparatus is set to a power-off state. Accordingly, it is possible to appropriately maintain the state in which the line head 40 is capped by the cap portions 61 in the power-off state.

Note that the controller 100 may bring the pin member 86 into the restriction state when the apparatus makes the transition to the power saving mode. The power saving mode is a mode in which the power supply to motors and sensors is stopped to suppress power consumption, and the controller 100 makes the transition of the power state from a normal mode to the power saving mode when the paper feeding standby state of the printer 1 reaches a predetermined time. By setting the pin member 86 in the restriction state when making the transition to the power saving mode, the movement of the line head 40 can be restricted when the apparatus is in the state of the power saving mode. As a result, for example, a state in which the line head 40 is capped by the cap portions 61 in the state of the power saving mode can appropriately be maintained. Further, accordingly, even when an irregular operation in which the outlet is pulled out without performing the regular power-off operation is performed, it is possible to increase the probability that the line head 40 is capped by the cap portions 61.

Note that in the printing standby state before the transition to the power saving mode state is made, the pin member 86 is preferably set in the restriction release state. This is because when the pin member 86 is in the restriction release state, the printing operation can be resumed quickly when the print job is received.

The present disclosure is not limited to the embodiment and modified examples described above, but various modifications can be made within the scope of the disclosure set forth in the appended claims, and it is obvious that these modifications also fall within the scope of the present disclosure.

For example, in the embodiment described above, there is adopted the configuration in which the pin member 86, that is, the restriction portion restricts the rotation of the rotating body 74, but in the configuration including the two rotating bodies (74A and 74B), when the rotation of one rotating body is restricted, there is a possibility that the phases of the two rotating bodies are shifted due to the backlash between the shaft 77 and the rotating bodies. Therefore, instead of restricting the rotation of either one of the two rotating bodies (74A, 74B), it is also preferable to provide a rotating body separately from the two rotating bodies (74A, 74B) and restrict the rotation of this rotating body.

What is claimed is:

1. A recording apparatus comprising:
a conveyance path configured to convey a medium in a conveyance direction;
a recording unit configured to perform recording on the medium, and to move in a direction in which the recording unit advances and retreats with respect to the conveyance path;
a cleaning unit configured to clean the recording unit by moving with respect to the recording unit; and
a restriction portion configured to switch between a restriction state in which movement of the recording unit is restricted and a restriction release state in which the movement of the recording unit is not restricted in accordance with an action of the cleaning unit.

2. The recording apparatus according to claim 1, wherein
a movement range of the cleaning unit includes an engagement position where the cleaning unit engages with the restriction portion, and
the restriction portion takes
the restriction state when the cleaning unit is located at the engagement position, and
the restriction release state when the cleaning unit is displaced from the engagement position.

3. The recording apparatus according to claim 2, further comprising
a moving device configured to move the recording unit, wherein
the moving device includes a rotating body, and
the restriction portion restricts rotation of the rotating body in the restriction state and allows the rotation of the rotating body in the restriction release state.

4. The recording apparatus according to claim 3, wherein
the rotating body includes a pinion constituting a rack-and-pinion mechanism,
the restriction portion includes a pin member configured to advance and retreat with respect to the pinion, and
the pin member is configured to
advance to a position where rotation of the pinion is inhibited in the restriction state, and
retreat to a position where the rotation of the pinion is allowed in the restriction release state.

5. The recording apparatus according to claim 4, wherein
the pinion has a restraint portion configured to restrain the pin member set in the restriction state.

6. The recording apparatus according to claim 4, wherein
the cleaning unit performs cleaning of the recording unit by linearly moving, and
the pin member advances and retreats with respect to the pinion by a swing of a lever member that swings to transmit a moving action of the cleaning unit to the pin member.

7. The recording apparatus according to claim 6, wherein
play is provided to an engagement region between the lever member and the pin member.

8. The recording apparatus according to claim 1, wherein
the recording unit is configured to eject a liquid from a plurality of nozzles, and
the cleaning unit wipes a nozzle surface of the recording unit by moving in a direction along the nozzle surface.

9. The recording apparatus according to claim 2, wherein
the recording unit is configured to eject a liquid from a plurality of nozzles,
the cleaning unit wipes a nozzle surface of the recording unit by moving in a direction along the nozzle surface, and
the engagement position is located on a moving path of the cleaning unit.

10. The recording apparatus according to claim 1, wherein
a controller configured to control the cleaning unit brings the restriction portion into the restriction state when the apparatus is brought into in a power-off state.

11. The recording apparatus according to claim 1, wherein
a controller configured to control the cleaning unit brings the restriction portion into the restriction state when the apparatus makes a transition to a power saving mode.
